(19) United States
(12) Patent Application Publication
(10) Pub. No.: US 2020/0264560 A1
(43) Pub. Date: Aug. 20, 2020

(54) RECTILINEAR-TRANSFORMING DIGITAL HOLOGRAPHY IN COMPRESSION DOMAIN (RTDH-CD) FOR REAL-AND-VIRTUAL ORTHOSCOPIC THREE-DIMENSIONAL DISPLAY (RV-OTDD)

(71) Applicant: Duan-Jun Chen, East Brunswick, NJ (US)

(72) Inventor: Duan-Jun Chen, East Brunswick, NJ (US)

(21) Appl. No.: 16/348,483

(22) PCT Filed: Dec. 7, 2018
(86) PCT No.: PCT/US2018/064621

§ 371 Date: May 8, 2019

Related U.S. Application Data
(60) Provisional application No. 62/708,417, filed on Dec. 8, 2017.
(60) Provisional application No. 62/762,834, filed on May 21, 2018.

(51) Int. Cl. G03H 1/22; G03H 1/08; G03H 1/04; G02B 5/32

(52) U.S. Cl. CPC G03H 1/2294; G03H 2223/19; G03H 1/0443; G03H 1/2249; G03H 1/0841; G03H 1/0808; G03H 1/2205; G02B 5/32; G03H 2210/32; G03H 2210/454; G03H 2001/226; G03H 2001/2278; G03H 2001/0825; G03H 2001/221; G03H 2225/32; G03H 1/0866

(57) ABSTRACT

A holographic 3D display system is described that (1) always presents true-colored and true-orthoscopic 3D images regardless of whether the object is thin or thick, or the image is virtual or real and (2) accomplishes an effective data/signal compression apparatus that accommodates to both off-the-shelf detector and display arrays, of both amicable gross array dimensions and palpable individual pixel sizes. It provides a rectilinear-transforming digital holography (RTDH) system for recording and displaying virtual, real, or both virtual and real, orthoscopic three-dimensional images, the system comprising: (a) a focal-plane compression-domain digital holographic recording/data capturing (FPCD-DHR) sub-system; (b) a 3D distribution network for receiving, storage, processing and transmitting the digital-holographic complex wavefront data signals generated by the digital complex wavefront decoder (DCWD) to at least one location; and (c) a focal-plane compression-domain digital holographic display (FPCD-DHD) sub-system located at the at least one location.

### § 1. RELATED APPLICTION(S)

The present application claims benefit to provisional application Ser. No. 62/708,417, filed on Dec. 8, 2017, titled “Rectilinear-Transforming Digital Holography System for Orthoscopic-&-True 3D Recording & Display” and listing Duan-Jun Chen and Albert Chen as the inventors (referred to as “the '417” provisional and incorporated herein by reference), and also claims benefit to provisional application Ser. No. 62/762,834, filed on May 21, 2018, entitled “Digital Focal-Plane Holography System for True Three-Dimensional Recording and Display of Dynamic Objects and Scenes” and listing Duan-Jun Chen and Jason Chen as the inventors (referred to as “the '834” provisional and incorporated herein by reference). The present invention is not limited to any requirements in the '417 and '834 provisional applications.

### § 2. BACKGROUND OF THE INVENTION

### § 2.1 Field of the Invention

The present description concerns digital holography. More specifically, the present description concerns systems for recording, encoding, and/or decoding digital holographic signals and displaying 3D images of 3D objects.

### § 2.2 Background Information

Conventional holography principles are generally well documented in literature. (See, for example, text by Graham Saxby and Stanislovas Zacharovas, Practical Holography, Fourth Edition, CRC Press, New York, 2016.) The first concept of holography of mixing a coherent object beam with a coherent reference beam (referred to as “interference”) was initially invented by Dennis Gabor (Nobel Laureate) as early as 1947 (now referred to as “in-line holography”), and his first paper regarding this very new discovery was published in 1948 (Nature, Vol. 161 (4098), p. 777-778, 1948). Gabor's discovery was historical as it established, for the first time, a viable means for recording and recovering (albeit indirectly) the phase information of a propagating electro-magnetic wavefront, including optical wavefront. Emmitt Leith and Juris Upatnieks first introduced the concept of the so termed “off-axis holography”, first for planar (2D) objects published in 1962 (Journal of the Optical Society of America, Vol. 52(10), p. 1123-1130), and then for 3D diffusing objects published in 1964 (Journal of the Optical Society of America, Vol. 54(11), p. 1295-1301). Leith and Upatnieks' version of holography further induced a substantial angular-offset (i.e., off-axis) to the reference beam with respect to the object beam prior to mixing/coupling of the two coherent beams. In principle, this angular-offset of the reference beam affords a substantial and effective carrier frequency between the two interfering beams, and thus makes the 3D image reconstruction/extraction process simpler and more practical to accomplish. Also, in 1962, Uri Denisyuk brought the previous work of Gabriel Lippmann (Nobel Laureate and a pioneer in earlier stage developments of color photographic films) to holography and produced the first white-light reflection holograms. Having an advantage of being viewed in true colors under ordinary incandescent light bulbs, a white-light reflection hologram involves the use of a thick optical recording emulsion (i.e., a volumetric media capable of registering sophisticated 3D interference fringes) deposited on top of a glass plate or a film, and thus would inevitably encounter further impediments should a technical transition take place from the volumetric holograms to digital detector arrays (normally in a 2D format).

FIGS. 1A-1C illustrate the general principle of operation of the conventional off-axis holography configuration of Leith and Upatnieks. In these figures, “PC” represents a protruded cylinder at a front side of a cube (as a “typical object” for the purpose of presentation). In FIG. 1A, a front face of the cube is defined by points A, B, C and D, and H represents a holographic film (or, alternatively, a planar electro-optic detector array), first used for image capturing and then used for image display, and \tilde{R} is an off-axis reference beam and Õ is an object beam. More specifically, FIG. 1A illustrates a conventional off-axis holography recording system, FIG. 1B illustrates a conventional orthoscopic and virtual 3D display/reconstruction arrangement (in which a reconstruction operation is performed using the same off-axis reference beam \tilde{R} as used for the recording embodiment), and FIG. 1C illustrates a conventional pseudo-scopic and real-3D display arrangement (in which a reconstruction by the reference's conjugate beam \tilde{R}* is used for the display). The conventional display system of FIG. 1B is orthoscopic but, the displayed 3D image of the object is virtual (i.e., an observer can only view the displayed 3D image from behind a holographic screen). In contrast, the conventional display system of FIG. 1C is real (i.e., an observer views the displayed 3D image in front of a screen). Unfortunately, however, the displayed image of the object is pseudo-scopic 3D (i.e., a front face of the object has been turned into a rear side from the viewer's point at display). Thus, it would be a desirable improvement upon such systems to provide a system which always displays orthoscopic 3D images of objects, regardless of whether virtual or real.

Secondly, in FIG. 1A, the optical interference fringe pattern formed at the recording plane (H) normally includes very high spatial frequencies and thus demands ultra-ordinarily high spatial resolutions of the recording media (H). The recording media (H, or hologram) can be an optical holographic film, whereby the system represents traditional optical holography. Alternatively, the recording media (H) can be an electro-optical detector array (e.g. CCD or CMOS array), whereby the system represents traditional electro-optical holography (or, referred to as traditional digital holography). Especially when the object is large in size or is located at a close vicinity of H, or both, a theoretically super-fine resolution of the detector array would require the array pixels to be built into a sub-micron scale, and thus poses an immediate challenge to the cost and the fabrication process. Further, in FIG. 1A, when the object is large or is located close to film plane (H), or both, a recording array of substantially large overall dimension is demanded, which presents a further cost challenge.

FIG. 2A represents a conventional system for focused-image holography, and FIG. 2B presents a conventional system for focused-image single-step rainbow holography. In these Figures, all references shared from FIGS. 1A-1C represent the same elements, “FD” denotes a focusing device (e.g., a lens or concave mirror reflector), and “HSA” represents a horizontal slit aperture (appearing in FIG. 2B only). First, considering FIG. 2A only, the upper portion illustrates the step(s) for recording, while the lower portion illustrates the step for display. The conventional system of FIG. 2A provides real, but approximately orthoscopic, 3D images. Specifically, the system works well only at a special situation where the object is extremely thin (i.e., when Δ₀=0), and is precisely positioned at an object distance of (2f) from focusing device (FD), where f is focal length of FD. However, for a 3D object in general (Δ₀>>0), the three linear magnification factors (Mₓ, M_{y} and M_{z}) from a 3D object to a 3D image vary substantively as the depth (Δ₀) varies. Since the three linear magnification factors are not maintained at constant values among all points of the 3D object, the system is not truly orthoscopic 3D (except for a special case in which an object depth approaches zero.)

Note that the only different arrangement from FIG. 2A to FIG. 2B is the added horizontal slit aperture (HSA), which is located between the 3D object and focusing device (FD). This slit-enabled version of focused-image single-step holography of FIG. 2B was initially developed by Stephen A. Benton and is now referred to as “rainbow holography”, or “embossed holography”. At right side of the optical image, there also appears an image of the horizontal slit aperture (HSA′). At top portion of FIG. 2B (i.e., the recording setup), there appears only one single image of the horizontal slit aperture (HSA′); this is because the recording system is supplied with a monochromatic light source (e.g., a laser beam). However, at bottom portion of FIG. 2B (i.e., the display setup), the display beam is now provided with a polychromatic lighting source (e.g., a so called “white-light beam” from a lamp). Due to the existence of multiple wavelengths in the polychromatic light beam, multiple images of the horizontal slit aperture are now formed at the right end, with different colored slits appearing at different heights and resembling the appearance of rainbow lines (and thus resulting in the so named “rainbow holograms”). Note that in FIG. 2B (lower portion), for simplicity and clarity, only one slit (HSA”) is shown, which presents a slit corresponding to merely one mono-color, e.g., a green color. In fact, many other slits of other colors also appear there, the color slits partially overlapping one another, with longer wavelengths appearing above the presented green slit and shorter wavelengths appearing below the green slit. When the viewer positions their eyes into a particular colored image slit, a 3D image with a particular color is observed. (See, for example, text edited by Stephen Benton, Selected Papers on Three-Dimensional Display, SPIE Milestone Series, Volume MS-162, Published by SPIE—the International Society for Optical Engineering, Bellingham, Wash., 2001.) Due to the ability to mass-produce holographic images using an optical embossing technique, embossed holograms stamped onto plastic surfaces have gained wide applications today in publishing, advertising, packaging, banking and counterfeiting industries. It should be noted that (1) the viewer observed image color is a monochromatic color, not full color nor RGB color, (2) the perceived color is dictated by the viewer-chosen particular color slit, and it's not a true color of the object (and thus the perceived color is “pseudo-color”), and (3) due to similar reasons in FIG. 2A, the system is not true orthoscopic 3D (except for a special case in which an object depth is very thin.)

FIGS. 3A and 3B demonstrate conventional Fourier Transform (FT) holography with a lens for 2D objects. More specifically, FIG. 3A illustrates the case in which the object is positioned at the precise front focal plane (FFP) and the detector array is positioned at the precise rear focal plane (RFP) of the Fourier Lens (FL), and in which the system is an exact Fourier Transform (FT) system, in terms of a wavefront's amplitude and phase. FIG. 3B illustrates a non-exact Fourier Transform (FT) system in which the object is positioned at the inner side of the front focal plane (FFP) and the detector array is positioned at the precise rear focal plane (RFP) of the Fourier Lens (FL). An exact Fourier Transform (FT) relationship is not valid in this system when considering both a wavefront's amplitude and phase. However, this system can be quite useful when a goal is to retain only the object's power-spectrum (PS), and the system indeed offers a much-improved overall power-throughput than FIG. 3A via an increased field-of-view by the much-reduced distance between object and the lens (and its aperture marked by diameter D_{L}). In FIGS. 3A and 3B, all references used in previous figures represent the same elements, D_{L} is a lens diameter or aperture, z₀ is a distance from a front focal point (FFP) to a plane object, FFP presents a front focal point or front focal plane, RFP presents a rear focal point or rear focal plane, FL is a Fourier Transform lens, and FH is a Fourier Transform hologram (also referred to as a focal plane hologram). The systems of FIGS. 3A and 3B are widely used for optical signal processing, albeit not in 3D display. (See, for example, text by Joseph W. Goodman, Introduction to Fourier Optics, Third Edition, Roberts & Company, Englewood, Colo., 2005; hereafter referred as “Text of Goodman”, in particular, Chapter 9. Holography.) In both FIGS. 3A and 3B, the object being captured must be extremely thin (virtually a 2D object). This is because the Fourier Transform (FT) relationship between an object plane and a detector plane requires a strict 2D object (with ideally zero depth). Thus, this system is not valid (or even approximately valid) for producing a Fourier Transform or power-spectrum of a generally thick 3D object, except for a special case wherein the object depth is extremely thin and any quadratic phase terms so introduced by a miniscule depth variation can be ignored (while performing a linear super-positioning process at the detector array).

As should be apparent from the foregoing discussions, it would be desirable to have a holographic 3D display system that (1) always presents true-colored and true-orthoscopic 3D images regardless of whether the object is thin or thick, and regardless of whether the image is virtual or real and (2) provides an effective data/signal compression apparatus that accommodates both off-the-shelf detector and display arrays, of both amicable gross array dimensions and palpable individual pixel sizes (i.e., averting excessively demanding either overly mammoth arrays nor ultra-ordinarily minuscule individual pixels, especially for applications to immense dimensioned 3D objects and scenes).

### § 3. SUMMARY OF THE INVENTION

Example embodiments consistent with the present description provide a holographic 3D display system that (1) always presents true-colored and true-orthoscopic 3D images regardless of whether the object is thin or thick, and regardless of whether the image is virtual or real and (2) accomplishes an effective data/signal compression apparatus that accommodates to both off-the-shelf detector and display arrays. Such example embodiments may do so, for example, by providing a rectilinear-transforming digital holography (RTDH) system for recording and displaying virtual, real, or both virtual and real, orthoscopic three-dimensional images, the system comprising: (a) a focal-plane compression-domain digital holographic recording/data capturing (FPCD-DHR) sub-system; (b) a 3D distribution network for receiving, storage, processing and transmitting the digital-holographic complex wavefront data signals generated by the digital complex wavefront decoder (DCWD) to at least one location; and (c) a focal-plane compression-domain digital holographic display (FPCD-DHD) sub-system located at the at least one location.

The focal-plane compression-domain digital holographic recording/data capturing (FPCD-DHR) sub-system may include, for example, (1) a coherent optical illuminating means for providing a reference beam and illuminating a three-dimensional object such that wavefronts are generated from points on the three-dimensional object, (2) a first optical transformation element for transforming and compressing all the wavefronts generated from the points of the three-dimensional object into a two-dimensional complex wavefront distribution pattern located at a focal plane of the first optical transformation element, (3) a two-dimensional focal plane detector array (FPDA) for (a) capturing a two-dimensional power intensity pattern produced by an interference between (i) the two-dimensional complex wavefront pattern generated and compressed by the first optical transformation element and (ii) the reference beam, and (b) outputting signals carrying information corresponding to captured power intensity distribution pattern at different points on a planar surface of the two-dimensional detector array, and (4) a digital complex wavefront decoder (DCWD) for decoding the signals output from the focal plane detector array (FPDA) to generate digital-holographic complex wavefront data signals. The two-dimensional focal plane detector array (FPDA) is positioned at a focal plane of the first optical transformation element, and a distance from the two-dimensional focal plane detector array (FPDA) to the first optical transformation element corresponds to a focal length of the first optical transformation element.

The focal-plane compression-domain digital holographic display (FPCD-DHD) sub-system may include (1) a digital phase-only encoder (DPOE) for converting the distributed digital-holographic complex wavefront data signals into phase-only holographic data signals, (2) second coherent optical illuminating means for providing a second illumination beam, (3) a two-dimensional phase-only display array (PODA) for (i) receiving the phase-only holographic data signals from the digital phase-only encoder, (ii) receiving the second illumination beam, and (iii) outputting a two-dimensional complex wavefront distribution based on the received phase-only holographic data signals, and (4) a second optical transformation element for transforming the two-dimensional complex wavefront distribution output from the two-dimensional phase-only display (PODA) array into wavefronts that propagate and focus into points on an orthoscopic holographic three-dimensional image corresponding to the three-dimensional object.

The two-dimensional phase-only display array (PODA) is positioned at a front focal plane of the second optical transformation element. A distance from the two-dimensional phase-only display array (PODA) to the second optical transformation element corresponds to a focal length of the second optical transformation element. The relationship between the captured three-dimensional object and the displayed three-dimensional image constitutes a three-dimensional rectilinear transformation. Finally, the displayed three-dimensional image is virtual orthoscopic, or real orthoscopic, or partly virtual and partly real orthoscopic with respect to the three-dimensional object.

### § 4. BRIEF DESCRIPTION OF THE DRAWINGS

FIGS. 1A-1C illustrate a general principle of operation of the conventional off-axis holography configuration of Leith and Upatnieks.

FIG. 2A illustrates a conventional system for focused-image holography, and FIG. 2B illustrates a conventional system for focused-image single-step rainbow holography.

FIGS. 3A and 3B illustrate conventional Fourier Transform (FT) holography with a lens for 2D (thin) objects.

FIGS. 4A and 4B illustrate two embodiments of the currently purposed real-and-virtual orthoscopic 3D recording and display systems, including a 3D distribution network. More specifically, FIG. 4A illustrates a system based on two two-dimensional convex transmission lenses (L₁ and L₂). In FIG. 4B, HRCMS is a holographic recording concave mirror screen and it replaces transmission lens L₁ in FIG. 4A, and HDCMS is a holographic display concave mirror screen and it replaces transmission lens L₂ in FIG. 4A.

FIG. 5 delineates a hypothetically synthesized/fused afocal optical system (SAOS). Specifically, FIG. 5 can be simply obtained from FIG. 4A (or 4B) by merging/fusing the upper-left optical recording sub-system and the upper-right optical display sub-system.

FIG. 6A presents the upper-left side subsystem of the system shown in FIG. 4B (i.e., a focal-plane compression-domain digital holographic recording (FPCD-DHR) subsystem (or called data capturing subsystem)).

FIG. 6B depicts example recording subsystem illustrating transformation/compression of a 3D object to a 2D pickup array (i.e., FPDA).

FIG. 6C presents a unique complex wavefront, having a unique normal direction and a unique curvature, at the focal-plane compression-domain (u₁, v₁) that is generated due to lights coming from a single point P(x₁, y₁, z₁) of a 3D object.

In FIGS. 6D and 6E, the area of a FQPZ (Fresnel-styled quadratic phase zone) is further illustrated in detail by FZA (Fresnel zone aperture/area).

FIGS. 7A-7D reveal controllable/amenable lateral and longitudinal speckle sizes at focal-plane compression-domain holography (i.e., relaxed speckle dimensions at focal plane for proper resolutions by off-the-shelf detector arrays).

FIG. 8 depicts synchronized stroboscopic laser pulses for single-step recording of dynamic objects at each temporal position.

FIGS. 9A and 9B illustrate reference-beam angular offset criterion for focal-plane compression-domain digital holographic recording (FPCD-DHR) subsystem, as well as typical objects/positions for (1) virtual and orthoscopic 3D, (2) real and orthoscopic 3D, and (3) partly virtual orthoscopic and partly real orthoscopic 3D displays, respectively.

FIGS. 10A-10D illustrate example wavefront forms of reference beams used for emulated functions of inverse-normalized-reference (INR) at focal-plane compression-domain digital holographic recording.

FIGS. 11A and 11B demonstrate merits of data conversion by digital complex wavefront decoder (DCWD) from mixed/interference phonic intensity pattern (H_{PI}) to complex wavefronts (H_{CW}).

FIG. 12 illustrates example components of a 3D data storage and distribution network.

FIG. 13A delineates the upper-right side subsystem of the system in FIG. 4B (i.e., a focal plane compression-domain digital holographic display (FPCD-DHD) subsystem).

FIG. 13B illustrates a transmission lens as example transformation element, illustrates 2D-to-3D display reconstruction (decompression).

FIG. 13C delineates a particular Fresnel-styled quadratic phase zone (FQPZ) that is uniquely selected/picked out at the display array by the orthogonality among different (numerous) wavefronts, generating a unique wavefront (having a unique normal direction and a unique curvature) that converges to a unique three-dimensional imaging point in the 3D image space.

FIG. 14A illustrates phase-only modulation process of one pixel of a conventional parallel aligned nematic liquid crystal (PA-NLC) transmission array.

FIG. 14B depicts phase-only modulation process of one pixel of a conventional elastomer-based (or piezo-based) reflective mirror array.

FIGS. 15A-15C illustrate a single element/pixel of parallelism-guided digital micro-mirror devices (PG-DMD).

FIGS. 16A-16C illustrates various electro-static mirror devices and their discrete stable displacement states of PG-DMD.

FIG. 17A illustrates a 2×2 segmentation from the complex input array (left side) and the equivalently encoded 2×2 phase-only array for output to display (right side), FIG. 17B illustrates pictorial presentation of three partitioned and synthesized functional pixels, and FIG. 17C illustrates a vector presentation of a Complex-Amplitude Equivalent Synthesizer (CAES) process with regard to each functional pixel.

FIG. 18A illustrates 1×2 segmentation and FIG. 18b illustrates a vector presentation of a functional pixel, demonstrating the 2-for-1 algorithm.

FIGS. 19A and 19B illustrate example ways to integrate separate red, green and blue colors. More specifically, FIG. 19A illustrates RGB partitioning at recording, while FIG. 19B illustrates RGB blending at display.

FIGS. 20A-20C illustrate alternative ways to provide horizontal augmentation of viewing parallax (perspective angle) by array mosaic expansions at both recording and display arrays.

FIG. 21 illustrates that a large screen may be implemented using optical telephoto subsystems having a large primary lens at both recording and display.

FIGS. 22A and 22B illustrate, for the system in FIG. 4B, that super-large viewing screens may be provided using multi-reflective panels.

FIG. 23A illustrates microscopic rectilinear transforming digital holographic 3D recording and display system.

FIG. 23B illustrates telescopic rectilinear transforming digital holographic 3D recording and display system.

FIG. 24 corresponds to FIG. 12, but simulated images (CG_{C}H(u₁,v₁), i.e., computer generated complex holograms) are input instead of (or in addition to) captured images.

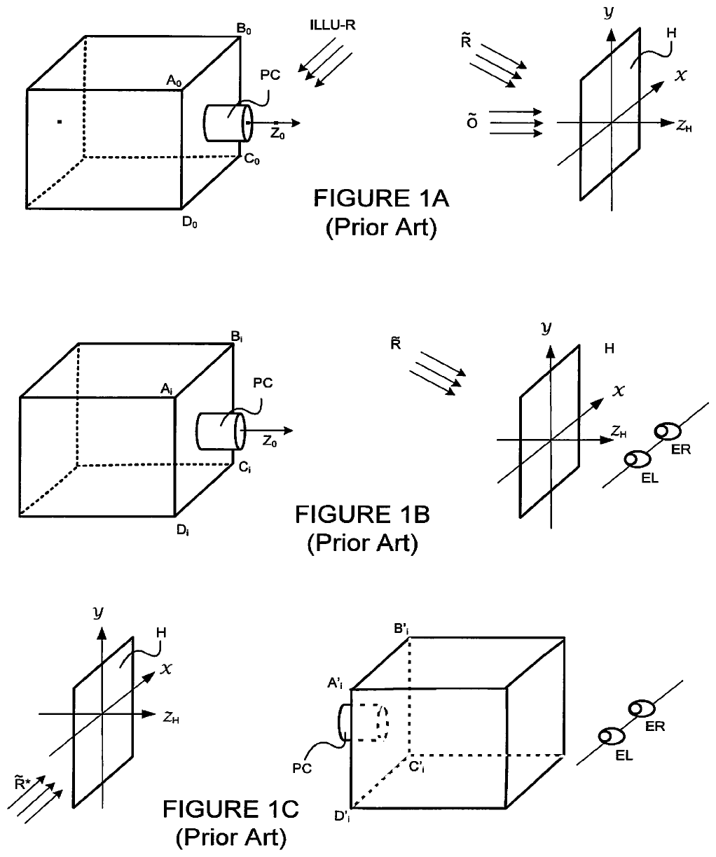

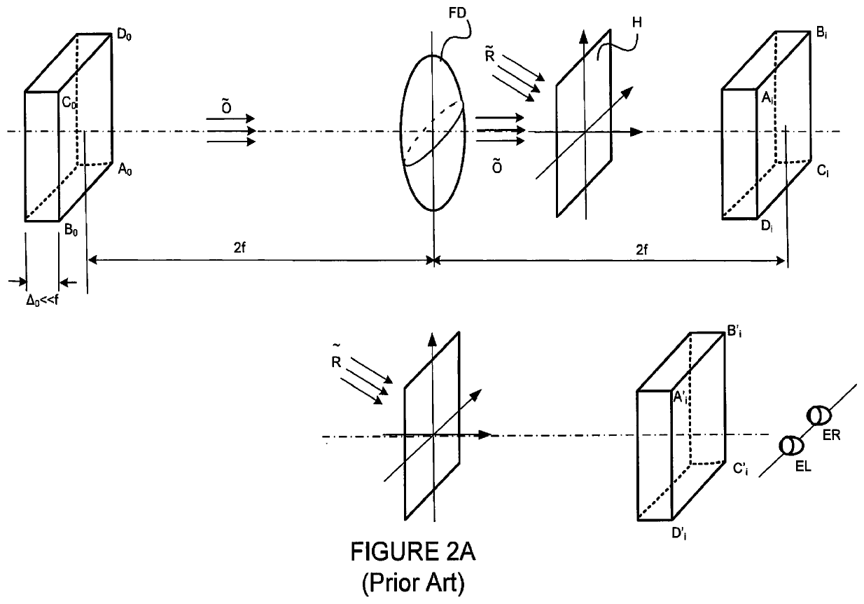

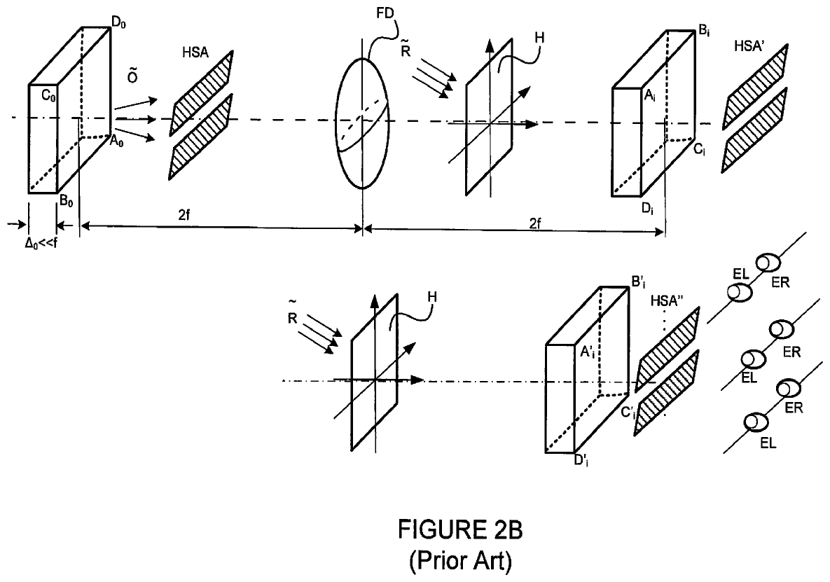

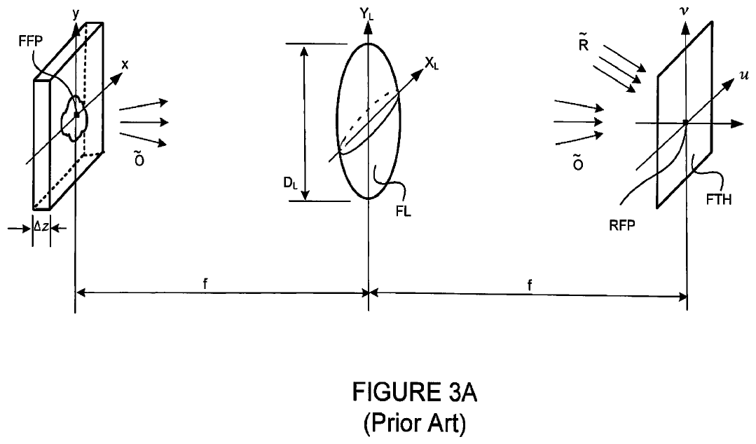

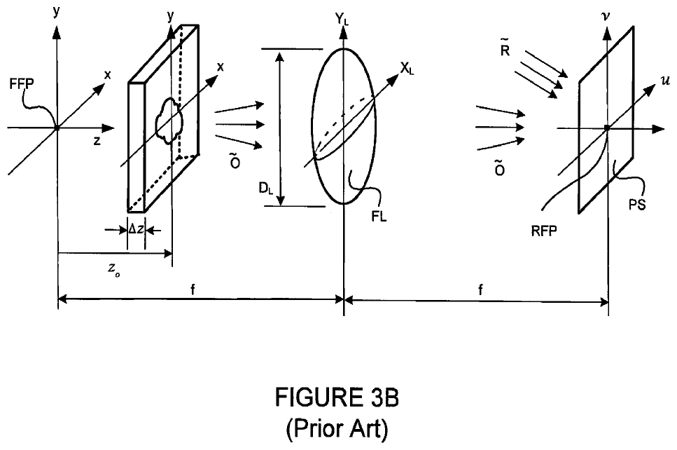

### § 5. DETAILED DESCRIPTION

### § 5.1 General 3D Recording and Display System Overview

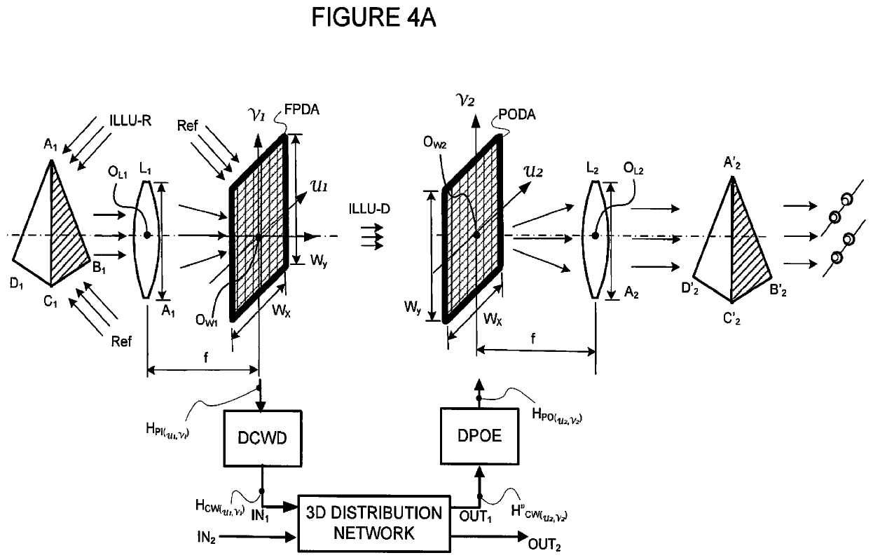

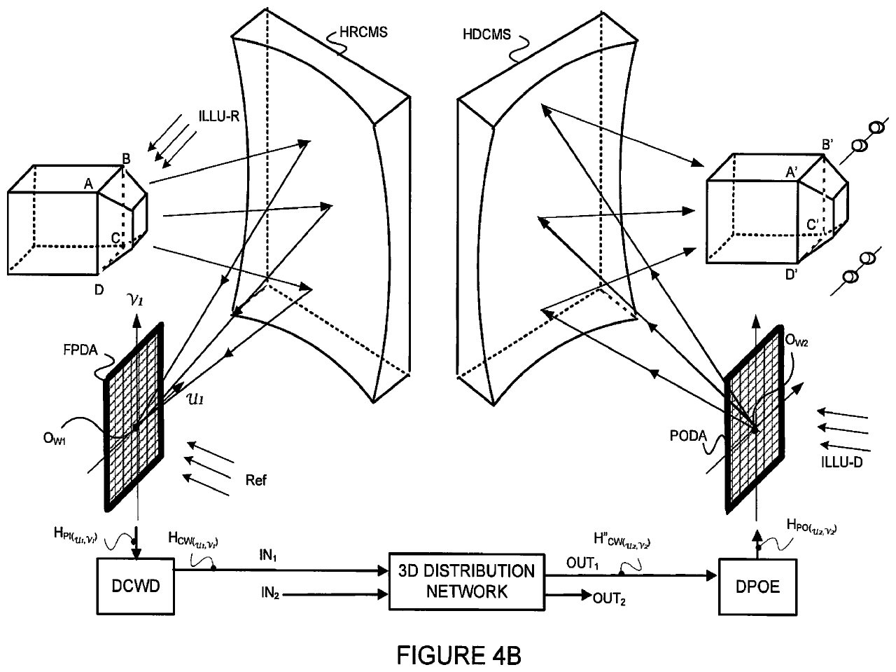

FIGS. 4A and 4B illustrate two embodiments of the currently purposed real-and-virtual orthoscopic 3D recording and display systems, including a 3D distribution network. In these figures, the upper left portion depicts a recording part of the system, the upper right portion depicts a display part of the system and the lower middle portion depicts the 3D distribution network for data receiving, processing/conditioning, storage, and transmitting. In these figures, any references used in the previous figures depict the same elements.

FIG. 4A illustrates a system based on two two-dimensional convex transmission lenses (L₁ and L₂). In FIG. 4A, lens L₁ also represents a general first optical transforming and compressing element in a general true-3D recording and display system. Lens L₁ has a back focal plane (u₁, v₁), which is also referred to as a focal-plane compression-domain. By definition, distance between L₁ and 2D compression-domain (u₁, v₁) equals to focal length (f) of lens L₁, i.e., O̅_̅{̅L̅1̅}̅O̅_̅{̅W̅1̅}̅=f. FPDA represents a focal-plane detector array, which is a 2D rectangular electro-optical detector array placed in the 2D focal-plane compression domain (u₁, v₁). Focal plane detector array (FPDA) can be made from a 2D CCD array or a CMOS array. FPDA's response at each pixel's position is proportional to power/intensity distribution at that pixel location. Optical amplitude at each pixel's position can be directly obtained by taking the square-root of the detected power/intensity, but the phase value of a wavefront each pixel's position cannot be directly obtained from detected power/intensity. Lens L₂ also represent a general second optical transforming element in a general true-3D recording and display system. Lens L₂ has a front focal plane (u₂, v₂), which is also called a focal-plane compression-domain. By definition, distance between L₂ and the 2D compression-domain (u₂, v₂) equals the focal length (f) of lens L₂, i.e., O̅_̅{̅L̅2̅}̅O̅_̅{̅W̅2̅}̅=f. PODA represents a rectangular phase-only display array that is placed in 2D focal plane/domain (u₂, v₂). DCWD represents a digital complex wavefront decoder/extractor, and DPOE represents a digital phase-only encoder (or synthesizer). The 3D object (shown as a pyramid) can be placed anywhere at left side of lens L₁ (i.e., a semi-infinity 3D space). The 3D image of a 3D object may be located at the right side of lens L₂, or at the left side, or partly located at its right side and partly located at its left side. When the 3D image is located at the right side of lens L₂, the 3D image appears as real and orthoscopic 3D to the viewer(s) located at the very right end. When the 3D image is located at the left side of lens L₂, the 3D image appears as virtual (behind a lens/screen) and orthoscopic. When the 3D image is partly located at the right side and partly located at the left side of lens L₂, the 3D image appears as partly real and orthoscopic, and partly virtual and orthoscopic.

In FIG. 4B, the system follows the same general principles of operation as shown in FIG. 4A. However, in FIG. 4B, a holographic recording concave mirror screen (HRCMS) replaces transmission lens L₁ in FIG. 4A, and a holographic display concave mirror screen (HDCMS) replaces transmission lens L₂ in FIG. 4A. In application, the example embodiment in FIG. 4B has some major advantages over that of FIG. 4A due to the use of concave reflective mirror screens at both the recording and display subsystems. More specifically, these advantages include (1) conveniently affording larger recording and display screens at both subsystems, (2) enabling optical folding-beam constructions at both subsystems, thus reducing overall system dimensions, and (3) eliminating, by use of the optical reflective mirrors, any possible chromatic dispersions/aberrations at both subsystems. Additionally, in both embodiments of FIGS. 4A and 4B, utilization of symmetric (i.e., identical) optical transforming elements at both recording and display subsystems can further improve 3D imaging quality and reduce or eliminate other possible kinds of dispersions/aberrations at displayed 3D optical images (e.g., lens L₂ is symmetric (i.e., identical) to lens L₁, and HDCMS is symmetric (i.e., identical) to HRCMS).

### § 5.2 Synthesized Afocal Optical System (SAOS)

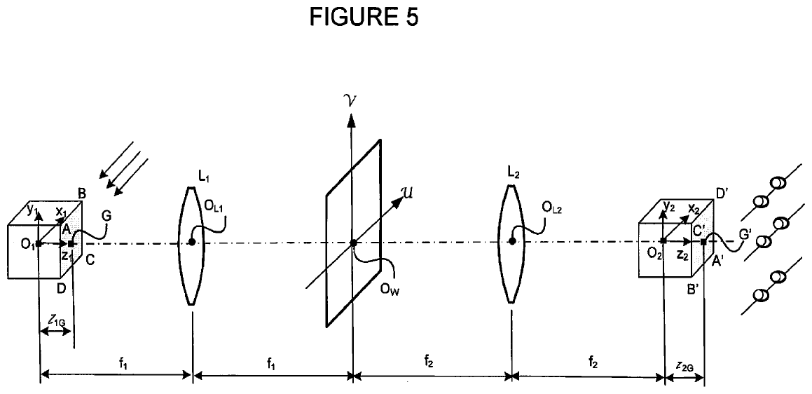

FIG. 5 is a hypothetically synthesized/fused afocal optical system (SAOS). Being hypothetical or conceptual, FIG. 5 serves the purpose of proof of concept and offers assistance to description and analysis of systems used in FIGS. 4A and 4B. More specifically, FIG. 5 can be simply obtained from FIG. 4A (or 4B) by merging/fusing the upper-left optical recording sub-system and the upper-right optical display sub-system, superposing (overlapping) the first compression-domain (u₁, v₁) with the second compression domain (u₂, v₂), and omitting the intervening elements including L₁, L₂, FPDA, PODA, DCWD, DPOE, as well as the 3D distribution network. Now the hypothetical system shown in FIG. 5 becomes an afocal optical system (AO) whose properties are well documented in literature. (See, for example, text by Michael Bass, Editor-In-Chief, Handbook of Optics/Sponsored by the Optical Society of America, McGraw-Hill, New York, 1995; in particular, Volume II, Chapter 2. Afocal Systems, written by William B. Wetherell.)

In FIG. 5, plane (u,v) is the overlapped or superimposed focal plane, it is now the rear focal plane of a first-half of the afocal optics (AO) and the front focal plane of a second-half of the afocal optics (AO). Plane (u,v) is thus referred to as a confocal plane of the afocal optics (AO), and the point of origin (O_{w}) of plane (u,v) is now referred to as confocal point of the afocal optics. One unique property of an afocal optical system is a general 3D rectilinear transforming relationship between an 3D input object and its 3D output image. That is, the three linear magnifications (Mₓ, M_{y}, M_{z}) in all three linear dimensions (x, y, z) are all constants and invariant with respect to space variations (i.e., Mₓ=M_{y}=constant, M_{z}=(Mₓ)²=constant).

Further, because focal length of both lenses (L₁ and L₂) here are identical (i.e., f₁=f₂−f), the afocal optical system in FIG. 5 is also a special tri-unitary-magnification system. That is, all the three linear magnifications in three directions equal to unity/one (i.e., Mₓ=M_{y}=M_{z}=1), and are invariant with respect to space variations. Thus, this hypothetically synthesized afocal optical system is referred to as a three-dimensional tri-unitary rectilinear transforming (3D-TrURT) optical system.

More specifically, in FIG. 5 when (f₁=f₂=f), the point of origin (O₁) of the 3D object space is defined at the front (left side) focal point of lens L₁, and the point of origin (O₂) of the 3D image space is defined at the rear (right side) focal point of lens L₂. As a result of the rectilinear transformation, note that the 3D object space coordinates (x₁, y₁, z₁) are transformed (mapped) into the 3D image space coordinates (x₂, y₂, z₂), a cube object in a 3D object space is transformed (mapped) into a cube image in a 3D image space, an object point G(0,0, z_{1G}) in a 3D object space is transformed (mapped) into an image point G′(0,0, z_{2G}) in a 3D image space, a distance z_{1G} in a 3D object space is transformed (mapped) into a distance z_{2G} (z_{2G}=z₁₀) in a 3D image space, and a surface ABCD of a 3D object is transformed (mapped) into a surface A′B′C′D′ of a 3D image.

Additionally, for purpose of proof of concept, we conceptually ignore any possible signal losses and/or noises induced from all the omitted elements in the fusion/merging transition from FIG. 4A (or 4B) to FIG. 5. Then we note that the displayed 3D images in FIGS. 4A (and 4B) are the same as those obtained in FIG. 5, if the objects for inputs are the same in both FIG. 4A (or 4B) and FIG. 5 (omitting any extra noises induced or/and any extra signal losses in FIG. 4A (or 4B)). Consequently, the systems of FIGS. 4A and 4B are now proved (indirectly) to possess 3D rectilinear transforming properties (virtually same as an afocal optical system). Thus, the systems in FIGS. 4A and 4B may be referred to as rectilinear-transforming digital holography (RTDH) systems.

Further noting that focal length of the first and second optical transforming elements in FIGS. 4A and 4B are also identical (i.e., f₁−f₂−f), also note that all the three linear magnifications in all three directions (from 3D object space to 3D image space) equal to unity/one (i.e., Mₓ=M_{y}=M_{z}=1), and invariant with respect to space variations. Thus, the systems in FIGS. 4A and 4B may also be referred to as tri-unity-magnifications rectilinear-transforming digital holography (TUM-RTDH) systems. In the end, the overall mapping relationship from a 3D object point (x₁, y₁, z₁) to a 3D image point (x₂, y₂, z₂) is a rectilinear transformation with tri-unity-magnifications (TUM), albeit an 180-degrees swap of coordinates is involved, i.e., (x₂, y₂, z₂)=(−x₁, −y₁, z₁).

### § 5.3 Focal-Plane Compression-Domain Digital Holographic Recording/Data-Capturing (FPCD-DHR) Sub-System

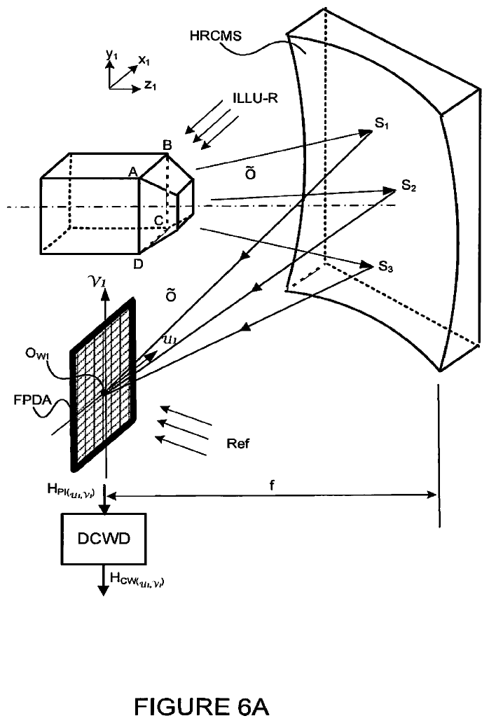

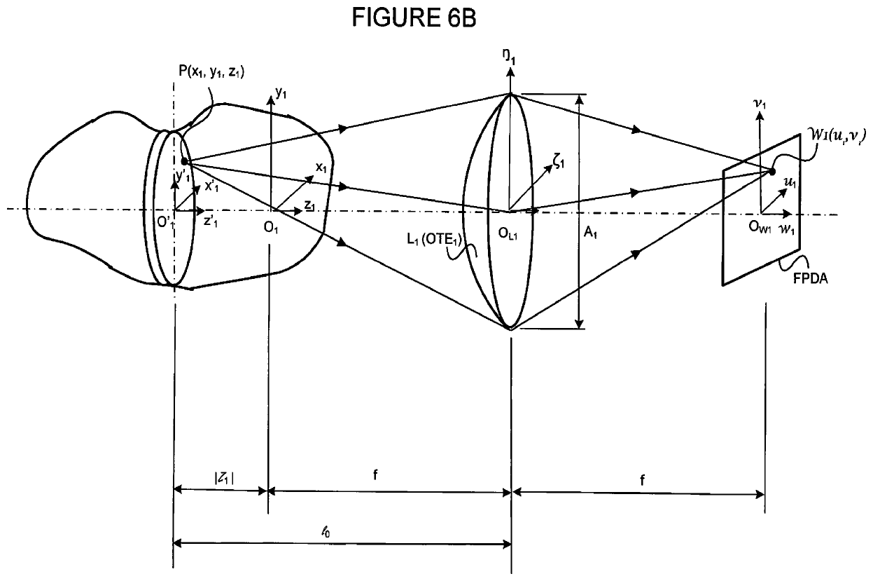

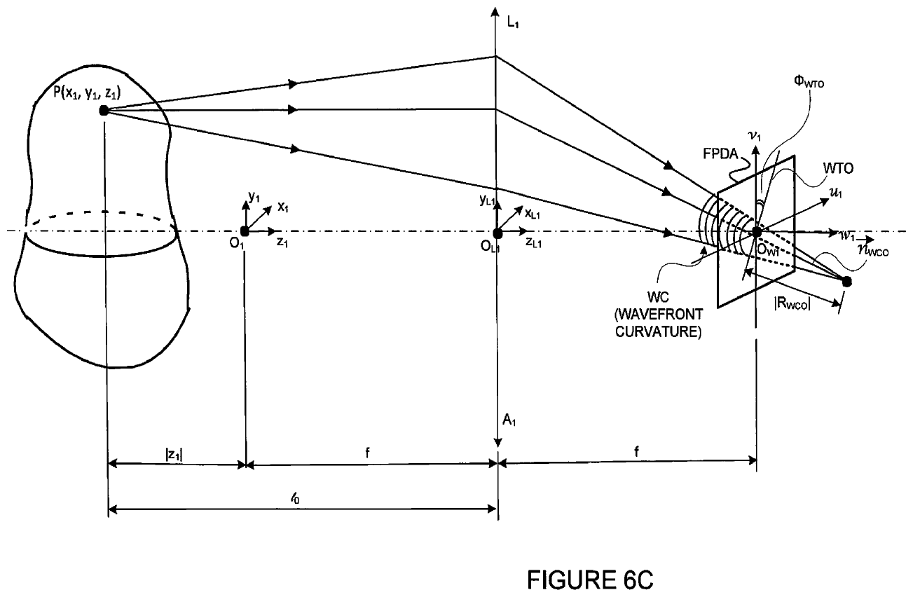

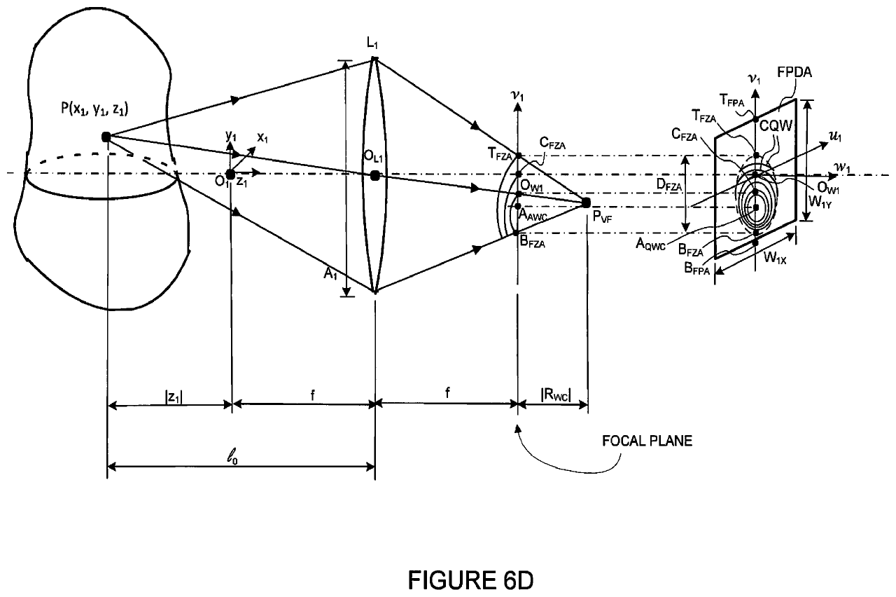

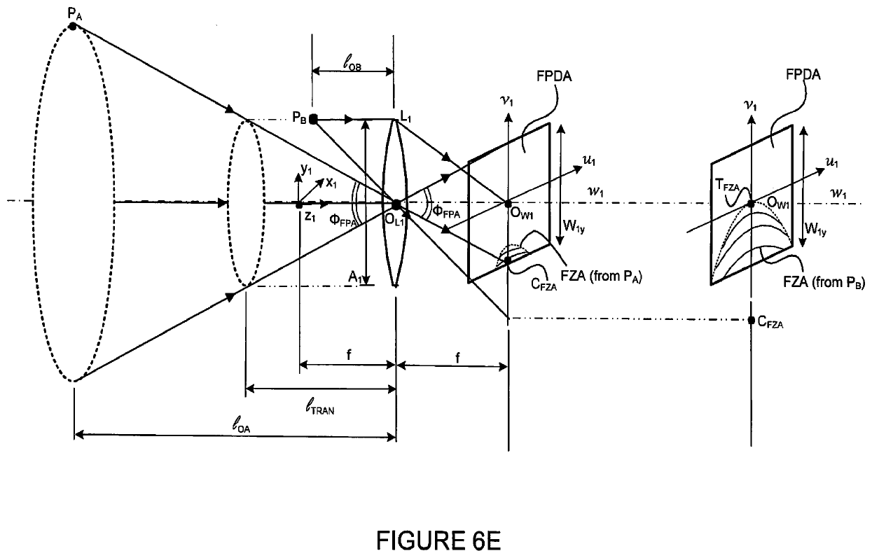

FIG. 6A presents the upper-left side subsystem of the system shown in FIG. 4B, i.e., the rectilinear-transforming digital holography (RTDH) system for recording and displaying virtual, real, or both virtual and real, orthoscopic three-dimensional images. This subsystem is referred to as the focal-plane compression-domain digital holographic recording (FPCD-DHR) subsystem, or simply the data capturing subsystem. In FIG. 6A, HRCMS stands for a holographic recording concave mirror screen, wherein HRCMS also represents a general optical transformation and 3D-to-2D compression element in a general FPCD-DHR subsystem. FPDA stands for a focal-plane detector array (e.g., a two-dimensional CCD or CMOS array), and DCWD stands for a digital complex wavefront decoder. The holographic recording concave mirror screen (HRCMS) can be made of a parabolic concave mirror reflector, or a spherical concave mirror reflector, or a spherical concave reflector accompanied by a thin Mangin-type corrector.

In FIG. 6A, the focal-plane compression-domain digital holographic recording (FPCD-DHR) subsystem (also called data capturing subsystem) comprises the following devices:

a coherent optical illuminating means for providing a reference beam (Ref) and a beam for illuminating (ILLU-R) a three-dimensional object such that wavefronts (Õ) are generated from points on the three-dimensional object;

an optical transformation element (e.g., HRCMS) for transforming and compressing all the wavefronts (Õ) generated from the points of the three-dimensional object into a two-dimensional complex wavefront distribution pattern located at a focal plane (u₁, v₁) of the optical transformation element (e.g., HRCMS);

a focal plane detector array (FPDA) for (1) capturing a two-dimensional power intensity pattern produced by an interference (mixture) between, (i) the two-dimensional complex wavefront pattern generated and compressed by the optical transformation element (e.g., HRCMS) and (ii) the reference beam (Ref), and (2) outputting signals carrying information corresponding to captured power intensity distribution pattern at different points on a planar surface of the two-dimensional focal-plane detector array (FPDA); and

a digital complex wavefront decoder (DCWD) for decoding the signals output from the focal plane detector array (FPDA) to generate digital-holographic complex wavefront data signals.

In FIG. 6A, the focal plane detector array (FPDA) is positioned at a focal plane of the optical transformation element (e.g., HRCMS), and wherein a distance from the focal plane detector array (FPDA) to the optical transformation element (e.g., HRCMS) corresponds to a focal length (f) of the optical transformation element (e.g., HRCMS).

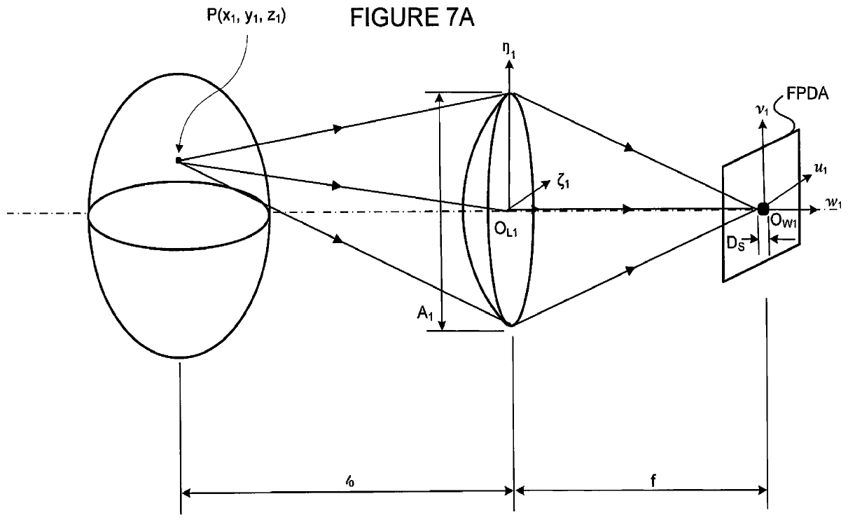

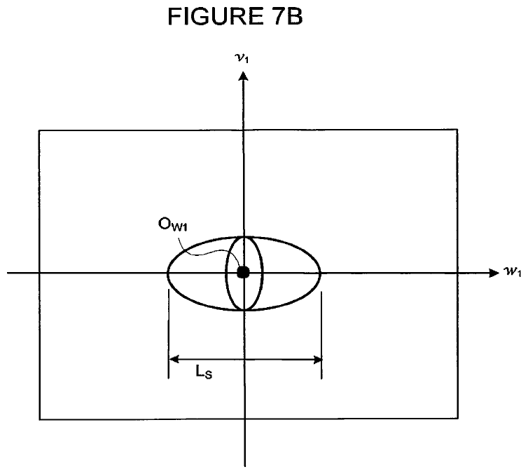

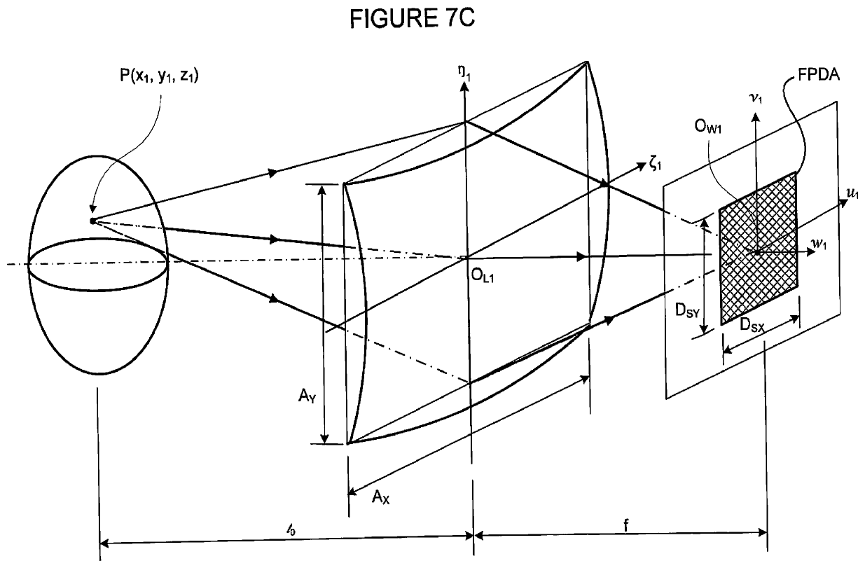

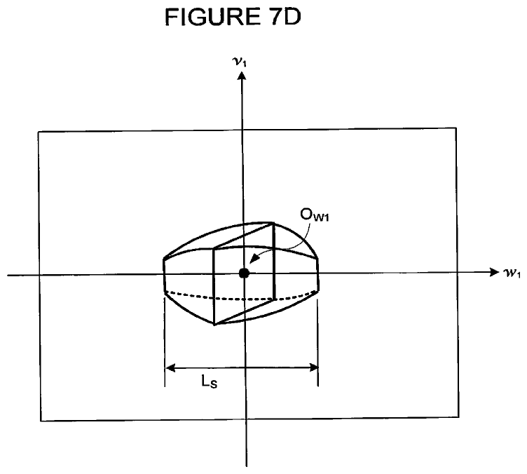

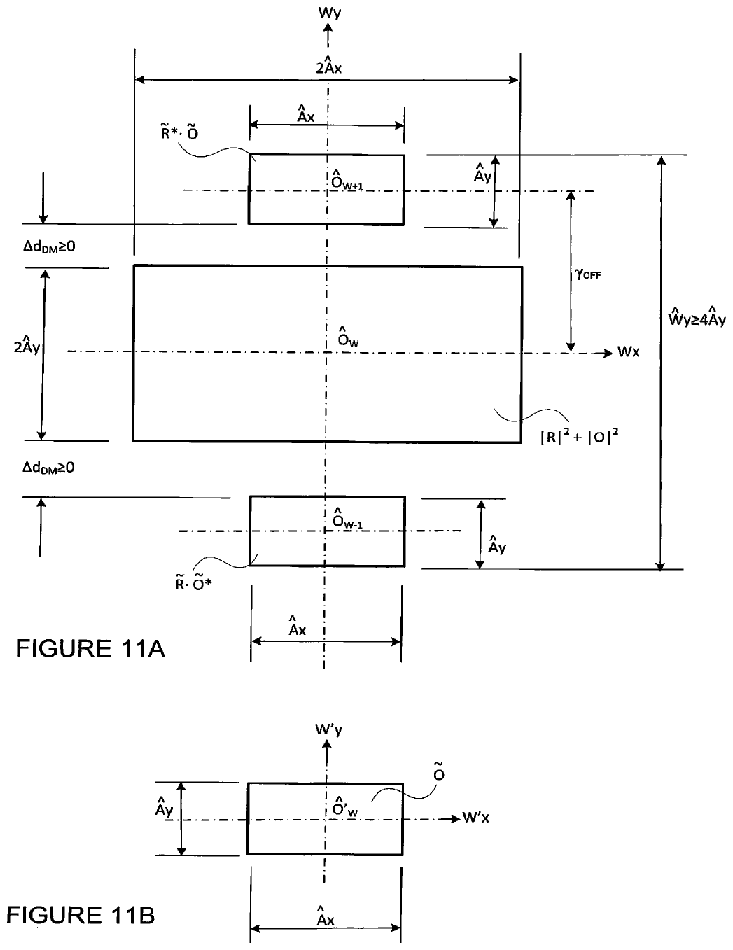

Also, in FIG. 6A, effects of optical and digital signal compressions can be explained in multiple aspects in the following: (1) optical signal compression means via a transformation from the 3D domain (x₁, y₁, z₁) to a 2D domain (u₁, v₁); (2) optical signal compression means via a large-aperture optical transformation element (e.g., HRCMS) from large-sized object(s) to a limited-size/small focal-plane detector array (FPDA); (3) optical generation of subjective speckle sizes with relaxed spatial resolution requirements attainable by an off-the-shelf photon detector array (See discussions below relating to FIGS. 7A-7D.); and (4) digital signal compression means achieved by relaxed (de-sampled) spatial-resolution requirement via a digital complex wavefront decoder (See discussions below relating to FIGS. 11A and 11B.).

FIG. 6B depicts a focal plane compression-domain digital holographic recording (FPCD-DHR) subsystem including a convex transmission lens (L₁), illustrating compression of a 3D object to a 2D pickup/detector array (FPDA). In FIG. 6B, the transmission lens (L₁) also represents a general optical transformation and compression (3D-to-2D) element (i.e., OTE₁) in a general FPCD-DHR subsystem, as also shown in FIGS. 4A, 4B and 6A. In FIGS. 6B-6E, the point of origin (O₁) of the 3D object space is defined at the front (left side) focal point of lens L₁ (or, OTE₁). A complex function, [symbol] [(u₁, v₁)<=(x₁,y₁,z₁)] is used to denote the complex wavefront response at the focal-plane compression-domain (u₁,v₁) due to lights coming from a single 3D point P(x₁, y₁, z₁) of a 3D object. To derive a general analytical solution for complex function [symbol] [(u₁, v₁)<=(x₁, y₁, z₁)], the following quadratic phase term is employed to represent the phase retardation induced by the lens (L₁) (or HRCMS), that is,

$$\vec{L {A}_{1}} ( {ξ}_{1} , {η}_{1} ) = exp [ \frac{- j π ( {ξ}_{1}^{2} + {η}_{1}^{2} )}{λ f} ] .$$

The above phase retardation term is imposed onto the lens aperture (A₁), and a Fresnel-Kirchhoff Diffraction Formula (FKDF) is applied to carry out complex function [symbol] [(u₁, v₁)<=(x₁, y₁, z₁)]. (See, e.g., Text of Goodman; in particular, Chapter 4. Fresnel and Fraunhofer Diffraction & Chapter 5. Wave-Optics Analysis of Coherent Optical Systems.) Then, after performing a Fresnel-Kirchhoff integral in plane (ξ₁,η₁) over aperture area (A₁) of lens L₁ and taking simplifications, the following analytical solution results for the complex function [symbol] [(u₁, v₁)<=(x₁, y₁, z₁)] at focal-plane compression-domain (u₁, v₁) as (i.e., a specific/unique wavefront due to light emerged from a single/unique 3D object point P(x₁, y₁, z₁)),

$$\vec{{H}_{1}} [ ( {u}_{1} , {v}_{1} ) < = ( {x}_{1} , {γ}_{1} , {z}_{1} ) ] = \frac{{C}_{1} {\vec{U}}_{1} ( {x}_{1} , {y}_{1} , {z}_{1} )}{f} exp [ \frac{j π {z}_{1} ( {u}_{1}^{2} + {v}_{1}^{2} )}{λ {f}^{2}} ] exp [ \frac{- j 2 π ( {x}_{1} {u}_{1} + {y}_{1} {v}_{1} )}{λ f} ] ,$$

wherein C₁ is a complex-valued constant, z₁=(f−lₒ), lₒ is distance from an object point to lens L₁ (or OTE₁ in a general FPCD-DHR subsystem), and [symbol] (x₁, y₁, z₁) denotes the optical complex amplitude at a single object point P(x₁, y₁, z₁).

Note that the above equation has two phase terms enclosed within two separated pairs of brackets. Inside the first pair of brackets is a quadratic phase term of (u₁, v₁) which is uniquely dominated by the longitudinal (depth) coordinate (z₁) of 3D point P(x₁, y₁, z₁); and inside the second pair of brackets is a linear phase term of (u₁, v₁) that is uniquely determined by the transverse (lateral) coordinates (x₁, y₁) of 3D point P. Thus, note that a complete set of the 3D coordinates of each individual 3D point P(x₁, y₁, z₁) is uniquely/individually coded into focal-plane compression-domain (u₁, v₁). This uniqueness of those 3D-point-specifically coded phase terms provides the foundation for (1) superposing multiple wavefronts coming from multiple 3D points of the object without virtually losing any 3D information, and (2) recovering/reconstructing each and every individual three-dimensional points at display from the superposed wavefront data at the FPDA.

As shown in FIG. 6B (shown transmission lens L₁ as example), a 3D to 2D compression from entire 3D object space (of all object points) to a focal plane domain (u₁,v₁) can be accomplished by integrating last equation over all three spatial coordinates, i.e.,

$$\vec{{H}_{1}} ( {u}_{1} , {v}_{1} ) = \frac{{C}_{1}}{f} {\int }_{{z}_{1}} exp [ \frac{j π {z}_{1} ( {u}_{1}^{2} + {v}_{1}^{2} )}{λ {f}^{2}} ]$$

$$\int {\int }_{( {x}_{1} , {y}_{1} )} {\vec{U}}_{1} ( {x}_{1} , {y}_{1} , {z}_{1} ) exp [ \frac{- j 2 π ( {x}_{1} {u}_{1} + {y}_{1} {v}_{1} )}{λ f} ] {dx}_{1} {dy}_{1} {dz}_{1}$$

Here, the integration takes place (analytically) firstly over 2D thin slice (x₁, y₁), before integrating over (z₁). This indicates, as illustrated in FIG. 6B, the operation of an analytically integral is taking place firstly over one 2D slice from the 3D object and then adding together with all other slices of the 3D object.

FIG. 6C shows a unique complex wavefront, having a unique normal direction and a unique curvature, at the focal-plane compression-domain (u₁, v₁) that is generated due to lights coming from a single point P(x₁, y₁, z₁) of a 3D object. In FIG. 6C, O_{W1} is an origin of the focal plane (u₁, v₁), R_{WCO} is a radius of a wavefront curvature at origin point O_{W1}, [symbol] _{WCO} is a normal directional vector (unit vector) of a wavefront curvature (WC) at origin O_{W1}. As illustrated by FIG. 6C, lights emerged from a three-dimensional object point P(x₁, y₁, z₁) generates a unique wavefront and produces a unique Fresnel-styled quadratic phase zone (FQPZ) at the focal plane detector array (FPDA), whereby the radius of curvature of the FQPZ is determined by the longitudinal coordinate (z₁) of the three-dimensional object point, and the normal-directional-vector of the FQPZ at origin point W₁(0,0) of the recording array is determined by the transverse coordinates (x₁, y₁) of the three-dimensional object point, i.e.,

$${R}_{WCO} = {f}^{2} / {z}_{1}$$

$$\vec{{n}_{WCO}} = \frac{〈 {x}_{1} / f , - {y}_{1} / f , 1 〉}{\sqrt{1 + {( {x}_{1} / f )}^{2} + {( {y}_{1} / f )}^{2}}}$$

In FIGS. 6D and 6E, the area of a FQPZ (Fresnel-styled quadratic phase zone) is further illustrated by FZA (Fresnel zone aperture/area). FIG. 6D illustrates a system in which 3D information for a point P(x₁, y₁, z₁) is not only encoded at origin point O_{W1}, but also encoded onto numerous other points within area of a Frenzel zone aperture (FZA) on focal plane. In FIG. 6D, FZA is a Fresnel Zone Aperture, point P is defined by coordinates (x₁, y₁, z₁), R_{WC} is a radius of wavefront curvature, P_{VF} is a virtual focusing point of wavefront. Value of wavefront curvature is controlled by R_{WC}=f²/z₁. When R_{WC} is negative (R_{WC}<0), z₁ is negative (z₁<0) and wavefronts at the focal plane are traveling/converging towards a virtual focusing point P_{VF} on the right side of FPDA; When R_{WC} is positive (R_{WC}>0), z₁ is positive (z₁>0) and wavefronts at the focal plane are traveling/diverged from P_{VF}, whereby P_{VF} turns into a focused point at the left side of FPDA. When R_{WC} is infinity (R_{WC}=∞), z₁ is zero (z₁=0) and wavefronts at the focal plane are planar wavefronts of collimated beams. FPDA is focal plane detector array, CQW are contour lines of a quadratic wavefront (in which optical phase is the same value at all points along each curved line), T_{FPA} is the top point of focal plane detector array (FPDA), B_{FPA} is the bottom point of focal plane detector array (FPDA), T_{FZA} is the top of Fresnel Zone Aperture (FZA), B_{FZA} is the bottom of Fresnel Zone Aperture (FZA). D_{FZA} is the diameter of Fresnel Zone Aperture (FZA), and size of D_{FZA} is linearly mapped from aperture A₁ of lens L₁ by the following relationship: D_{FZA}=(f/l₀)A₁. C_{FZA} is the geometric center of Fresnel Zone Aperture (FZA) whose coordinates are given by: C_{FZA}=[(−f/l₀) x₁, (−f/l₀) y₁]. A_{Q}WC is the apex of the quadratic wavefront curvature (QWC) whose coordinates are given by: A_{QWC}=[(f/z₁) x₁, (f/z₁) y₁].

FIG. 6E illustrates that in practice, focal plane detector array (FPDA) is not made as big as illustrated in FIG. 6D. That is, W₁ₓ and W_{1y} are much smaller than might be inferred from FIG. 6D. Note that not all of the Fresnel Zone Aperture (FZA) is encompassed by FPDA. Note also that if either of the following two conditions are met, one can consider 3D information to be adequately encoded. In FIG. 6E, focal plane detector array (FPDA) is illustrated twice whereas the first/left FPDA shows the FZA resulting from a far object point P_{A} and the second/right FPDA shows the FZA resulting from a near object point P_{B}.

$$\overline{{O}_{W 1} {C}_{FZA}} \leq \frac{{W}_{1 y}}{z} \qquad Condition 1$$

For point P_{A} (far objects/points, where l_{OA}>f): as l_{OA} increases, area of FZA decreases (that is, the Fresnel zone aperture shrinks), and C_{FZA} moves closer to O_{W1}. But, so long as

$$\overline{{O}_{W 1} {C}_{FZA}} \leq \frac{{W}_{1 y}}{z} ,$$

it means that 50% of FZA is on focal plane detector array (FPDA), or C_{FZA} is on or above B_{FPA}, or C_{FZA} is enclosed in FPDA.
Condition 2: T_{FZA} is on or above O_{W1}.
For point P_{B} (near object/points, where l_{OB}<f): when l_{OB} decreases, FZA increases (that is, the Frenzel zone aperture expands), and C_{FZA} moves farther from O_{W1}. But, so long as T_{FZA} is on or above O_{W1}. This means that 50% or more of focal plane detector array (FPDA) is filled by FZA. Note that P_{B} is enclosed in a cylindrical volume of diameter A₁, and length L_{TRAN}, where L_{TRAN}=A₁/Φ=f (A₁/W_{1y}), where Φ_{FPA} is an angular speed of FPDA (shown in vertical dimension), and where (l_{OA}>lₜᵣₐₙ), lₜᵣₐₙ denotes a distance of a typical “nearby object”, and l_{OA} denotes a distance of a typical “far object”.

### § 5.4 Controllable/Amenable Speckle Sizes for FPDA

FIGS. 7A-7D illustrate controllable/amenable lateral and longitudinal speckle sizes for a focal-plane compression-domain digital holographic recording subsystem in FIGS. 4A, 4B, 6A and 6B (i.e., relaxed speckle dimensions at focal plane for proper resolutions by off-the-shelf detector arrays). More specifically, FIG. 7A illustrates such controllable/amenable speckles with a circular aperture of recording screen in terms of the lateral speckle size (D_{S}, also called transversal speckle size). That is, a subjective speckle size (D_{S} is a speckle diameter) at focal plane detector array (FPDA) is independent of object size and object distance from the screen. Specifically, D_{S}=1.22λf/A₁ (whereby f/A₁=F_{#}, also called F-number), so that D_{S} can be adjusted at the time of a system design by controlling such design parameters as focal length (f) and aperture (A₁) of an optical transformation element (e.g., lens L₁). Based on Equation above (D_{S}−1.22 f/A₁), the subjective speckle size (D_{S}) formed here is independent/invariant of the specific object distance (lₒ) from an object point to the recording lens (or called “recording screen”); and it is indeed independent/invariant of the full specific 3D coordinates (x₁, y₁, z₁) of the 3D object point. (See, for example, text by Duan-Jun Chen, Computer-Aided Speckle Interferometry (CASI) and Its Application to Strain Analysis, PhD Dissertation, State University of New York, Stony Brook, N.Y., 1993; in particular, Section 2.2. Optimal Sampling of Laser Speckle Patterns, p. 7-16.) This kind of subjective speckle pattern (recorded indirectly behind the presence of lens L₁) is different (advantageous) from a case of an objective (direct) speckle pattern (with no presence of lens L₁), whereas objective speckles are often not only too tiny, but also, they vary rapidly with respect to distances/locations of an object to a recording plane (a film or detector array). At the time of recording, assume a reference beam is tilted straight up or down from the object beam optical axis. In this case, fringes of interface pattern become nearly or substantially horizontal, and S is the fringe spacing, where S≤D_{S}/2 (in order to be resolvable at recording and retrievable after recording (See, e.g., discussions relating to FIG. 11A.)). The pixel (sampling) resolution at recording subsystem at focal plane detector array (FPDA) is P_{X}≤D_{S}/2 and P_{y}≤S/2≤D_{S}/4. Further, at a display subsystem, the effective complex pixel (sampling) resolution at both horizontal and vertical dimensions can be de-sampled/compressed by a factor of two times (2×). Thus, the effective (functional) complex pixel resolution at display is P_{X}≤D_{S}/4 and P_{Y}≤D_{S}/8. (Note the further spatial de-sampling/compression effects, shown in FIGS. 11A and 11B.)

FIG. 7B illustrates such controllable/amenable speckles with circular aperture of recording screen, in terms of the longitudinal speckle size. In FIG. 7B, Lₛ is the longitudinal speckle size (i.e., a length or range that a speckle is in focus). In practice, we assume L_{S}=(f/A₁) D_{S}. In a general design, A₁<<f Thus, L_{S}>>D_{S}. Therefore, in a general system, the longitudinal speckle size is significantly larger than the lateral/transversal speckle size.

FIG. 7C illustrates such controllable/amenable speckles with rectangular aperture of recording screen, in terms of lateral (i.e., transversal) speckle sizes (D_{SX} and D_{SY}). A_{X} and A_{Y} are the width and height, respectively, of the aperture screen. D_{SX}, the speckle horizontal dimension at focal plane detector array (FPDA), is expressed as D_{SX}=2λf/A_{X}, and D_{SY}, the speckle vertical dimension at FPDA, is expressed as D_{SY}−f/A_{Y}. Similar to the case in FIG. 7A, here we define F_{# X}=f/Aₓ, and F_{# Y}=f/A_{y}, wherein F_{# X} and F_{# Y} are referred to as F-numbers in the x-dimension and the y-dimension, respectively. Also, based on Equations above (D_{SX}=λf/A_{X} and D_{SY}=λf/A_{Y}), subjective speckle size (D_{SX}×D_{SY}) formed here is independent/invariant of the specific object distance (lₒ) from an object point to the recording lens (or called “recording screen”); and is actually completely independent/invariant of the entire 3D coordinates (x₁, y₁, z₁) of the specific 3D object point (thus having an apparent advantage over an objective (direct) speckle case). Similar to the case of a circular aperture, when the reference beam is introduced to generate substantially horizontal fringes, the fringe spacing (S) needs to be S≤D_{SY}/2 in order to be resolvable at recording and retrievable afterwards. (See, e.g., the discussions relating to FIG. 11A.) The pixel (sampling) resolution at a recording subsystem at FPDA is P_{X}≤D_{SX}/2 and P_{Y}≤S/2≤D_{SY}/4. Further, at a display subsystem, the effective complex pixel (sampling) resolution at both horizontal and vertical dimensions can be de-sampled/compressed by a factor of two times (2×). Thus, the effective (functional) complex pixel resolution is P_{X}≤D_{SX}/4 and P_{Y}≤D_{SY}/8. (Note the further spatial de-sampling/compression effects shown in FIGS. 11A and 11B.)

Finally, FIG. 7D illustrates such controllable (amenable) speckles with rectangular aperture of recording screen in terms of a longitudinal speckle size (L_{S}). In a general design, A_{X}<<f and A_{Y}<<f. Thus L_{S}>>D_{SX} and L_{S}>>D_{SY}. Similar to the case of a circular aperture, in a general system, the longitudinal speckle size is significantly larger than the lateral/transversal speckle size.

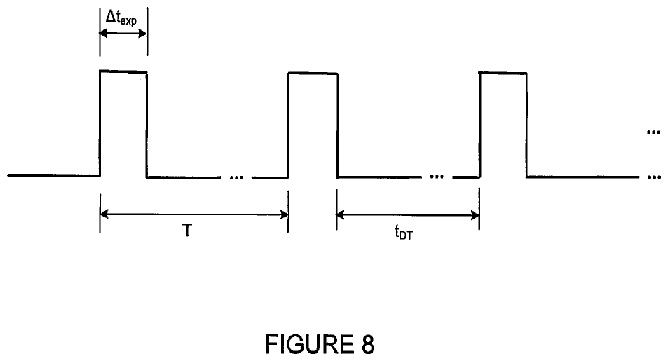

FIG. 8 illustrates synchronized stroboscopic laser pulses for single-step recording of dynamic (fast moving) objects at each temporal position. T is a frame time of recording FPDA. The time for frame data transfer from FPDA (where FPDA and laser pulse are in synch) is t_{DT}. The laser exposure time width is Δtₑₓₚ, where Δtₑₓₚ<<T. In general, the shorter the Δtₑₓₚ, the faster a moving/flying object that can be captured without suffering substantial motion-induced blurry effects. If we assume 0.10 m (e.g.) is a maximum object motion allowable within an exposure time, the table in the following demonstrates examples of allowable Δtₑₓₚ as a function of the maximum possible object speed (Vₘₐₓ, in m/s):

| | | | | | | | | | | | | | | |
|---|---|---|---|---|---|---|---|---|---|---|---|---|---|---|
| Vₘₐₓ (m/s) | 100 | m/s | 10 | m/s | 1 | m/s | 100 | mm/s | 10 | mm/s | 1 | mm/s | 0.1 | mm/s |
| Δtₑₓₚ (s) | 1 | ns | 10 | ns | 100 | ns | 1 | μs | 10 | μs | 100 | μs | 1 | ms |

### § 5.5 from Intensity Hologram to Complex Wavefronts Hologram—Digital Complex Wavefront Decoder (DCWD)

### § 5.5.1 Reference Beams and Criteria for Reference Angular Offset

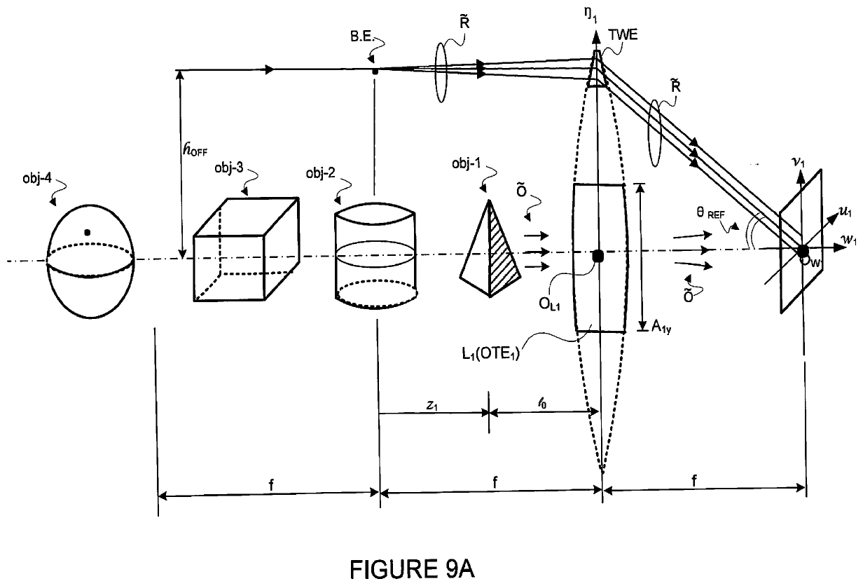

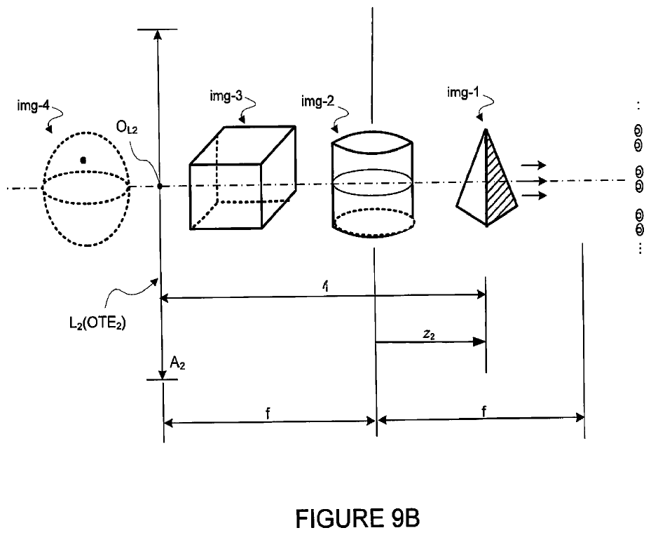

Referring back to the digital complex wavefront decoder (DCWD) of FIGS. 4A, 4B and 6A, FIGS. 9A and 9B illustrate reference-beam angular offset criterion for focal-plane compression-domain digital holographic recording (FPCD-DHR) subsystem. Also demonstrated in FIGS. 9A and 9B are typical objects/positions for (1) virtual and orthoscopic 3D, (2) real and orthoscopic 3D, and (3) partly virtual orthoscopic and partly real orthoscopic 3D displays, respectively. In FIG. 9A, \tilde{R} denotes the reference beam, Õ denotes the object beam, A_{1Y} denotes optical aperture of lens L₁ in vertical direction and point O_{L1} is origin of lens L₁, B.E. is a beam expander, TWE is a transmission wedge element (made of polymer plastics or glass), point O_{W1} is origin of focal-plane compression-domain (u₁, v₁), Θ_{REF} is the angular offset (i.e., off-axis angle) of the reference beam with respect to system optical axis, and [sin(Θ_{REF})] denotes an oblique spatial frequency offset of the reference beam from system optical axis. In order for the object beam to be resolvable at recording and retrievable afterwards (See discussions relating to FIG. 11A.), the required oblique spatial frequency offset of the reference beam is: sin(Θ_{REF})≥1.5/F_{# Y}, where F_{# Y} is the F_{number} in vertical direction of recording lens L₁, and F_{# Y}=f/A_{1y}.

Further in FIG. 9A, there are four representative objects, namely obj-1, obj-2 and obj-3, and obj-4, respectively. Notice that these objects are positioned at different distances at left side from lens L₁, wherein lens L₁ also represents OTE₁ (first optical transformation element) in a general system. Use (lₒ=f−z₁) to denote the distance from lens L₁ to an arbitrary point on an object. Note that: (1) obj-1 is located between lens L₁ and front focal plane of lens L₁, having a distance from lens L₁ less than a focal length (0<lₒ<f); (2) obj-2 is located at a vicinity of front focal plane of lens L₁, having a distance from lens L₁ approximately equal to a focal length (lₒ-f); (3) obj-3 has a distance from lens L₁ larger than a focal length and less than two-times of focal length (f<lₒ<2f); and (4) obj-4 has a distance away from lens L₁ larger two-times of focal length (lₒ>2/). Further note that in FIG. 9A, the 3D object space is a semi-infinity space defined by −∞<z₁<f.

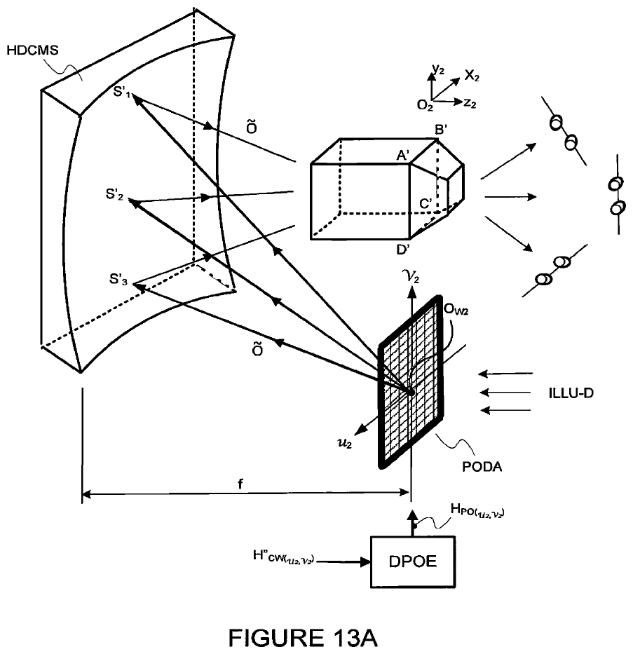

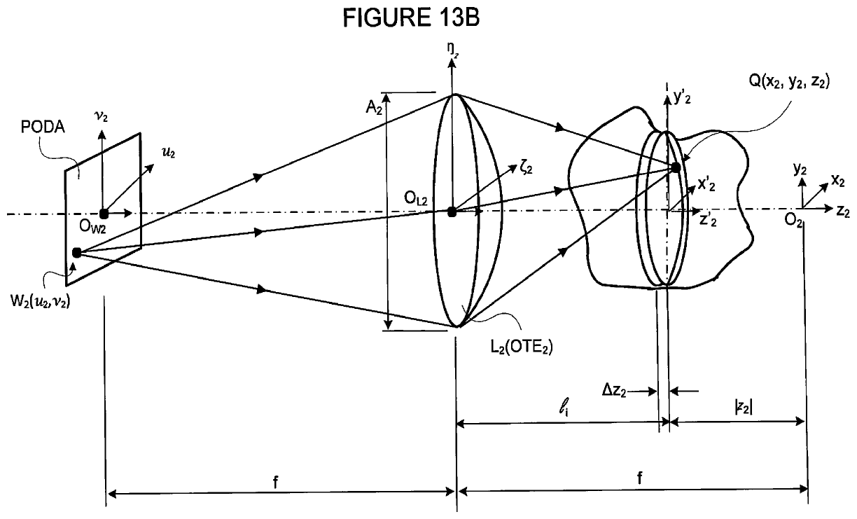

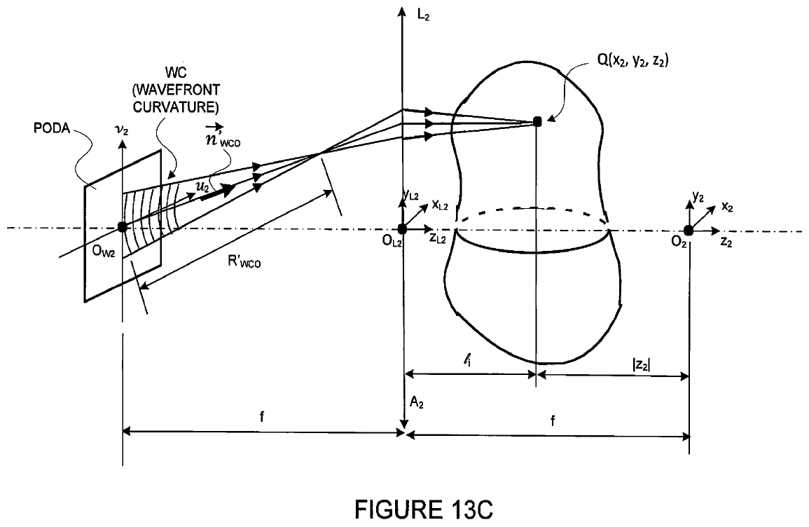

FIG. 9B shows displayed 3D imaging results (using a 3D display subsystem as shown in FIGS. 4A, 4B and 13A-C) of the four objects demonstrated in FIG. 9A. Let us use (lᵢ=f+z₂) to present the distance from lens L₁ to an arbitrary point on an object. Specifically, for each of the four representative objects, namely obj-1, obj-2 and obj-3, and obj-4, the corresponding 3D images displayed in FIG. 9B are, img-1, img-2 and img-3, and img-4, respectively.

In FIG. 9B, lens L₂ has aperture A₂, whereas aperture A₂ also appears a display screen to viewers, and lens L₂ also represents OTE₂ (second optical transformation element) in a general system. To viewers located at the very right end, 3D images img-1, img-2 and img-3 all appear real and orthoscopic (appearing in front of a display screen A₂), while 3D image img-4 appears virtual and orthoscopic (appearing behind a display screen A₂). Further, as shown in FIG. 9B, the 3D image space is a semi-infinity space defined by (−∞<z₂<f), whereas the 3D images are real and orthoscopic when (−f<z₂<f) and virtual and orthoscopic when (z₂<−f).

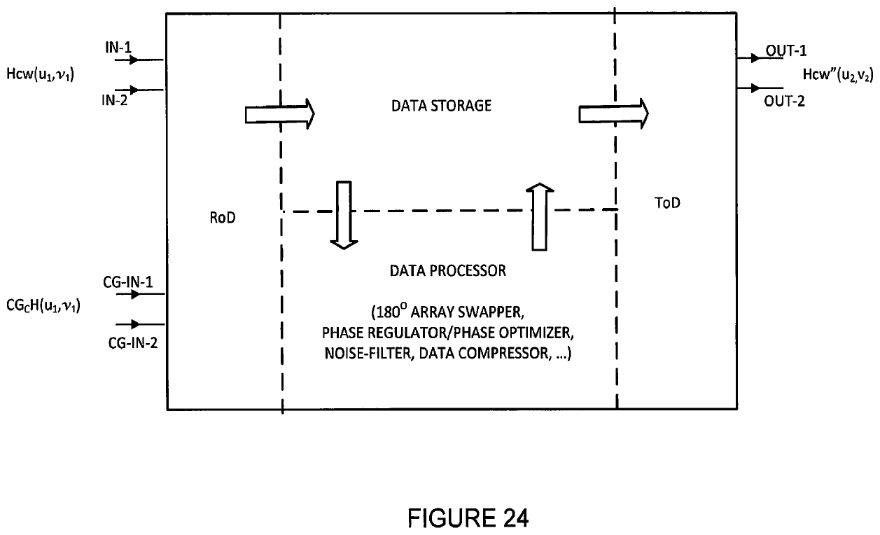

Additionally, in FIG. 9A, suppose another larger object (not shown, say obj-5) is formed by extending and merging obj-3 and obj-4 (i.e., by simply filling the space in between obj-3 and obj-4). In FIG. 9B, we would call the 3D image of obj-5 as img-5. To the viewers located at the very right end, 3D image img-5 would appear partially real and orthoscopic (part of the 3D image appearing in front of a display screen A₂), and partially virtual and orthoscopic (part of the 3D image appearing behind a display screen A₂). Also, referring to FIG. 24, some (or all) displayed 3D images in FIG. 9B could be from computer simulated virtual reality objects (VRO).

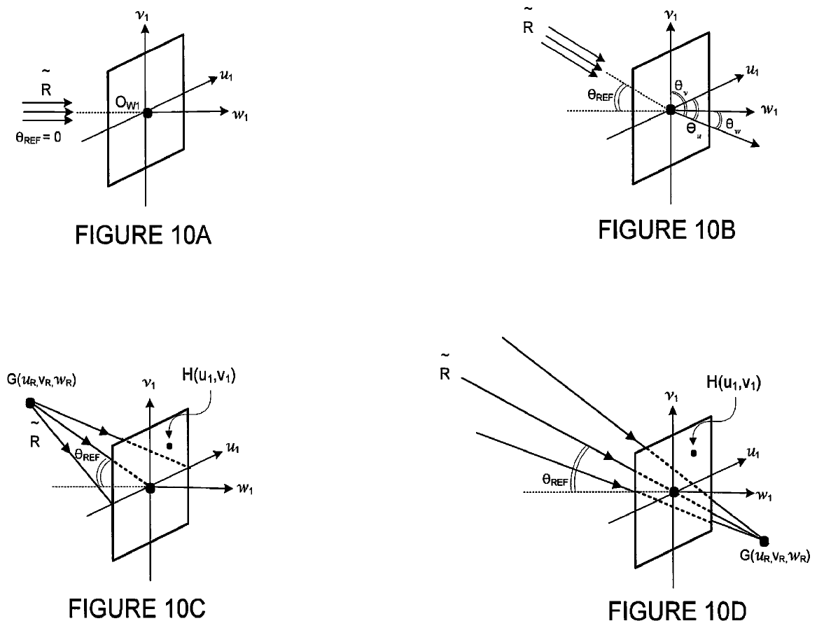

FIGS. 10A-10D illustrate example wavefront forms for reference beams used at focal-plane compression-domain digital holographic recording subsystem (in FIGS. 4A, 4B and 6A). In these figures, \tilde{R} is a reference beam with a complex wavefront (or phase distribution). FIG. 10A illustrates an expanded and collimated beam that is in-line (on-axis) with respect to system's optical axis (Θ_{REF}=0), FIG. 10B illustrates an expanded and collimated beam having an angular offset (off-axis angle) with respect to optical axis (Θ_{REF}), FIG. 10C illustrates a diverging beam (with off-axis angle Θ_{REF}), while FIG. 10D illustrates a converging beam (with off-axis angle Θ_{REF}). The symbol ϕ_{REF}(u₁, v₁) is used to present the phase term of a reference wavefront while it is impinging at the focal-plane domain (u₁,v₁).

Particularly, for FIG. 10A:

ϕ_{REF}(u₁,v₁)=0,

For FIG. 10B:

$${Φ}_{REF} ( {u}_{1} , {v}_{1} ) = \frac{2 π}{λ} [ {u}_{1} cos ( {θ}_{u} ) + {v}_{1} cos ( {θ}_{v} ) ] ,$$

For FIG. 10C, a beam diverged from a real sourcing point G(u_{R}, v_{R}, w_{R}) located at left side of focal-plane domain (w_{R}<0):

$${φ}_{REF} ( {u}_{1} , {v}_{1} ) = \frac{2 π}{λ} \overline{GH} = \frac{2 π}{λ} \sqrt{{( {u}_{1} - {u}_{R} )}^{2} + {( {v}_{1} - {v}_{R} )}^{2} + {( {w}_{R} )}^{2}} ,$$

wherein G̅H̅ is distance between real point source G(u_{R}, v_{R}, w_{R}) and a point H(u₁, v₁) located at the focal-plane domain,

For FIG. 10D, a beam converging towards a virtual sourcing point G(u_{R}, v_{R}, W_{R}) located at right side of focal-plane domain (w_{R}>0):

$${φ}_{REF} ( {u}_{1} , {v}_{1} ) = - \frac{2 π}{λ} \overline{GH} = - \frac{2 π}{λ} \sqrt{{( {u}_{1} - {u}_{R} )}^{2} + {( {v}_{1} - {v}_{R} )}^{2} + {( {w}_{R} )}^{2}} ,$$

wherein G̅H̅ is distance between virtual point source G(u_{R}, v_{R}, w_{R}) and a point H(u₁, v₁) located at the focal-plane domain

For all four reference beam forms in FIGS. 10A-10D, let A(u₁,v₁) be the 2D amplitude distribution of the reference beam, and let [symbol] (u₁,v₁) the complex wavefront function of the reference beam while it is impinging at the focal-plane domain (u₁,v₁), then:

[symbol]

(u₁,v₁)=A(u₁,v₁)exp[jϕ_{REF}(u₁,v₁)].

For a special case, when the 2D amplitude distribution of the wavefront is a constant across the focal-plane domain (u₁,v₁), then the amplitude is set to unity [A(u₁,v₁) e 1], and a simplified complex wavefront function for the reference beam can be expressed as,

[symbol]

R(u₁,v₁)=exp[jϕ_{REF}(u₁,v₁)].

Additionally, when the amplitude distribution of reference beam on focal plane (u₁,v₁) is not uniform, an on-site calibration for the reference beams in all FIGS. 10A-10D can be readily performed in real-time. This can be done by temporally blocking the object beam, and collecting the power distribution at the detector array (for a short time duration St). If it is assumed that the collected intensity/power distribution pattern is POWER_{REF}(u₁, v₁), the calibrated amplitude distribution of the reference beam can then be expressed as:

A(u₁,v₁)=\sqrt{POWER_{REF}(u₁,v₁)}.

FIG. 11 demonstrates effects of data conversion from phonic power intensity pattern (H_{PI}) to complex wavefronts (H_{CW}) in FIGS. 4A, 4B and 6A-E, by means of spectral analysis. The data conversion is performed by the digital complex wavefront decode (DCWD), for merits of reduced spatial resolution requirements at a display (e.g., as shown in FIGS. 4A, 4B and 13A-C). Here, domain (Wₓ, W_{y}) delineates spectrum of signals shown up in focal-plane domain (u₁,v₁). Specifically, FIGS. 11A and 11B illustrate 2D spectral distributions of (a) intensity hologram (H_{P1}), and (b) complex-hologram (H_{CW}), when a rectangular holographic recording screen aperture is used (See FIG. 7C for aperture dimensions Aₓ and A_{y}.). There is a linear scaling factor of (1/f) between the aperture dimensions Aₓ and A_{y} of FIG. 7C and the spectral dimensions of FIGS. 11A and 11B, i.e., Âₓ=Aₓ/f, Â_{y}=A_{y}/f and Wₓ=ξ₁/f, W_{y}=η₁/f.

Effects of decoding from intensity-hologram (real-and-positive data array) to complex-hologram (where effects are illustrated at spectral domain) are shown in terms of FIG. 11A vs FIG. 11B. In FIG. 11A, |\tilde{R}+Õ|² is the optical power intensity sensed by the detector pickup array (i.e., FPDA), where R represents a reference beam and Õ represents an object beam. The 2D distribution of this optical power intensity in focal plane (u₁, v₁) is also called a 2D pattern of interference fringes between the object beam (Õ) and reference beam (\tilde{R}). This 2D pattern of interference fringes has three orders/terms (0^{th}, +1^{st}, −1^{st}), respectively, as shown inside the three pairs of parentheses in the following equation:

|\tilde{R}+Õ|²=(|\tilde{R}|²+|Õ|²)+(\tilde{R}*Õ)+(\tilde{R}Õ*),

whereas \tilde{R}* and Õ* are the conjugates (with opposite phase terms) of \tilde{R} and Õ, respectively. Spectra of above three orders/terms (0^{th}, +1^{st}, −1^{st}) are shown in FIG. 11A, in middle, top and bottom positions, respectively. The single term to be utilized and decoded in FIG. 11A is the term sitting at top, i.e., ( [symbol] Õ). γ_{OFF} is spatial frequency offset (or called carrier frequency) of the reference beam relative to the object beam. Here, γ_{OFF} is related to Θ_{REF} by,

γ_{OFF}=sin(Θ_{REF}).

where Θ_{REF} is shown in FIGS. 9A and 10A-D. Also, from spectrum of FIG. 11A, in order to have the three spectral orders (0th, −1st, +1st) well separated (thus retrievable afterwards) from each other, it is apparent the criteria for the spatial frequency offset is,

γ_{OFF}>1.5Ã_{y}.

Further, on spectrum of FIG. 11A, we perform a spatial frequency shifting of (−γ_{OFF}), and apply a low-pass filter to it. Now, we receive a “down-sized” spectral pattern of object beam (Õ) as shown in FIG. 11B, which is the same (exact) spectrum of the decoded complex wavefronts (H_{CW}). From FIG. 11A to FIG. 11B, it is evident that a wide power spectrum distribution (2Ãₓ×4Ã_{y}) is effectively reduced to a narrow one (Ãₓ×Ã_{y}), thus resulting the significant reduction/compression of spatial resolution requirement from the electro-optically recorded phonic intensity pattern (H_{PI}) to the decoded complex wavefronts (H_{CW}) via DCWD. This significant data reduction/compression advantageously (1) reduces resolution requirement at the display array, and (2) reduces optical power waste at display.

### § 5.5.2 Emulated Function of Inverse-Normalized-Reference (INR)

In DCWD (digital complex wavefront decoder), the functional role of an emulated function of inverse-normalized-reference [ [symbol] (u₁,v₁)] is to retrieve the original object-generated wavefront [ [symbol] (u₁,v₁)] from a particular useful term (i.e., [symbol] *(u₁,v₁) [symbol] (u₁,v₁) (See top term in FIG. 11A.)), among the three terms in the recorded interference intensity hologram:

[symbol]

(u₁,v₁)[ [symbol] *(u₁,v₁) [symbol] (u₁,v₁)] [symbol] (u₁,v₁)

Thus, the requirement for [symbol] (u₁,v₁) is,

[symbol]

(u₁,v₁)= [symbol] (u₁,v₁)/[A(u₁,v₁)]²

wherein A(u₁,v₁) denotes amplitude of [symbol] (u₁,v₁), and [symbol] (u₁,v₁) is emulated complex wavefront function of the reference beam (see example reference beam forms in FIGS. 10A-10D). In a special case, when amplitude of the wavefront is a constant (i.e. uniform at FPDA), we let A(u₁,v₁) [symbol] 1, then we have,

[symbol]

(u₁,v₁)= [symbol] (u₁,v₁).

In such a special case, the emulated complex function of inverse-normalized-reference is reduced to an emulated complex function of the reference beam itself (who's amplitude is uniform within the area of FPDA in the focal-plane compression-domain (u₁,v₁)).

### § 5.6 Data Conditioning, Storage and Distribution Network

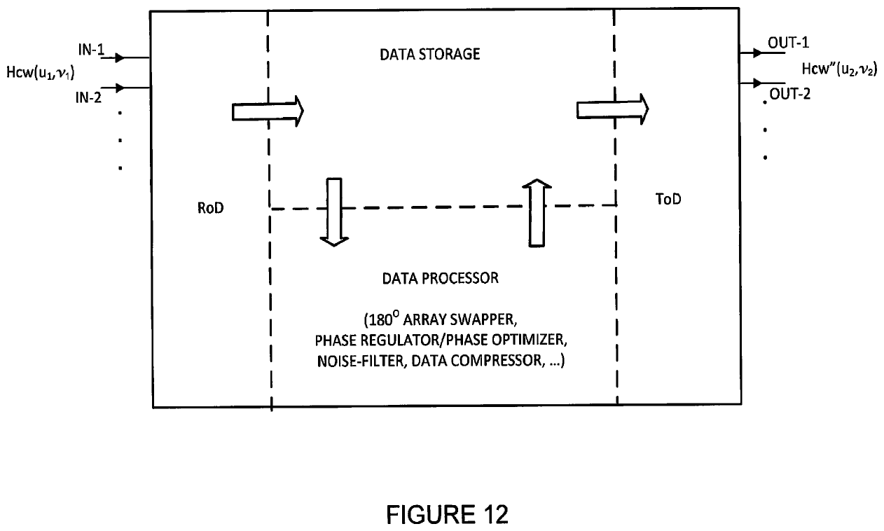

Referring back to the 3D distribution network in FIGS. 4A and 4B, FIG. 12 illustrates example components of such a 3D data storage and distribution network. As shown, the network may include a receiver-on-demand (RoD), a transmitter-on-demand (ToD). The network may also include further/additional components of data conditioning/processing, such as an 180° array swapper from domain (u₁, v₁) to (−u₂, −v₂), a phase regulator/optimizer, noise filter, and data compressor.

### § 5.7 Focal Plane Compression-Domain Digital Holographic Display (FPCD-DHD) Sub-System

FIG. 13A shows the upper-right side subsystem of the system in FIG. 4B, i.e., the rectilinear-transforming digital holography system for recording and displaying virtual, real, or both virtual and real, orthoscopic three-dimensional images. In the focal plane compression-domain digital holographic display (FPCD-DHD) subsystem of FIG. 13A, HDCMS stands for a holographic display concave mirror screen, wherein HDCMS also represents a general optical transformation (2D-to-3D) element in a general FPCD-DHD subsystem. PODA stands for a phase-only display array, and DPOE stands for a digital phase-only encoder. The holographic display concave mirror screen (HDCMS) can be made of a parabolic concave mirror reflector, or a spherical concave mirror reflector, or a spherical concave reflector accompanied by a thin Mangin-type corrector. The focal plane compression-domain digital holographic display (FPCD-DHD) subsystem comprises the following devices:

a digital phase-only encoder (DPOE) for converting the distributed digital-holographic complex wavefront data signals into phase-only holographic data signals;

a coherent optical illuminating means for providing an illumination beam (ILLU-D);

a two-dimensional phase-only display array (PODA) for (i) receiving phase-only holographic data signals, (ii) receiving the illumination beam, and (iii) outputting a two-dimensional complex wavefront distribution based on the received phase-only holographic data signals; and

an optical transformation element (e.g., HDCMS) for transforming the two-dimensional complex wavefront distribution output from the two-dimensional phase-only display array (PODA) into wavefronts (Õ) that propagate and focus into points on an orthoscopic holographic three-dimensional image corresponding to the three-dimensional object.

As shown in FIG. 13A, the two-dimensional phase-only display array (PODA) is positioned at a front focal plane of the optical transformation element (OTE₂, e.g., HDCMS), and wherein a distance from the two-dimensional phase-only display array (PODA) to the optical transformation element (e.g., HDCMS) corresponds to a focal length (f) of the optical transformation element.

FIG. 13B, showing a transmission lens (L₂) as an example, illustrates 2D-to-3D display reconstruction (decompression), wherein the transmission lens (L₂) also represents a general optical transformation (2D-to-3D) element (OTE₂) in a general FPCD-DHD subsystem. Here, as illustrated, the analytical reconstruction operation can first take place point-by-point within one 2D slice, and then move to a next 2D slice, so that all 3D points of the entire 3D image are recovered in the end.

Regarding the 3D rectilinear transformation, recall in FIGS. 6B-6E, the point of origin (O₁) of the 3D object space is defined at the front focal point (left side) of lens L₁. In contrast, in the display subsystem (as shown in FIGS. 13B and 13C), the point of origin (O₂) of the 3D image space is defined at the rear focal point (right side) of lens L₂. As a result of the rectilinear transformation, note that the 3D object space coordinates (x₁, y₁, z₁) of FIGS. 6A-6E are now transformed (mapped) into a 3D image space coordinates (x₂, y₂, z₂) of FIGS. 13A-13C, a distance |z₁| in a 3D object space is transformed (mapped) into a distance |z₂| in a 3D image space (|z₂|=|z₁|), and an arbitrary 3D point P(x₁, y₁, z₁) on a 3D object is now transformed (mapped) into a 3D point Q(x₂, y₂, z₂) on the displayed 3D image, wherein the 3D mapping relationship is extremely simple from the object space to the 3D image space, i.e., x₂=x₁, y₂=y₁ and z₂=z₁.

Noticing the reconstruction procedures here are generally the reversed procedures of those used in the recording subsystem, note that some similarities exist between the two subsystems. In FIGS. 13A-13C, a complex analytical function, [symbol] [(x₂,y₂,z₂) (u₂,v₂)], is used to denote the complex response at a reconstructed (focused) 3D image point Q(x₂, y₂, z₂), originated from a single point of the focal-plane compression-domain W₂(u₂, v₂). For a general closed-form solution for ( [symbol] ₂[(x₂,y₂,z₂)∥(u₂,v₂)], a similar quadratic phase term is used to represent the phase retardation induced by the lens (L₂) (or HDCMS), in the following (within A₂, aperture of lens L₂),

$$\vec{L {A}_{2}} ( {ξ}_{2} , {η}_{2} ) = exp [ \frac{- j π ( {ξ}_{2}^{2} + {η}_{2}^{2} )}{λ f} ]$$

Similarly, let us apply a Fresnel-Kirchhoff Diffraction Formula (FKDF) and carry out a Fresnel-Kirchhoff integral in plane (ξ₂, η₂) over aperture area (A₂) of lens L₂. (For details of FKDF, see Text of Goodman, Chapters 3-5.) Simplifying, we arrive at,

$${U}_{2} [ ( {x}_{2} , {y}_{2} , {z}_{2} ) \vert \vert ( {u}_{2} , {v}_{2} ) ] = \frac{{C}_{2} \vec{{H}_{2}} ( {u}_{2} , {v}_{2} )}{f}$$

$$exp [ \frac{- j π {z}_{2} ( {u}_{2}^{2} + {v}_{2}^{2} )}{λ {f}^{2}} ] exp [ \frac{- j 2 π ( {u}_{2} {x}_{2} + {v}_{2} {y}_{2} )}{λ f} ] ,$$

where C₂=Constant (complex), z₂ (lᵢ−f), lᵢ is distance from a 3D image point to the optical transformation element (OTE₂, e.g., HDCMS), [symbol] (u₂,v₂) stands for the complex value of wavefronts at a single point W₂(x₂,y₂,z₂) in the PODA.

FIG. 13B shows 2D to one focused 3D point reconstruction from wavefronts [symbol] (u₂,v₂) distributed over a whole PODA. In an analytic form, this is carried out by a 2D integration over the entire focal-plane domain (u₂, v₂). A complex function [symbol] (x₂,y₂,z₂) is used to denote the pointwise reconstructed complex value at a single focused 3D image point at Q(x₂,y₂,z₂). Complex function [symbol] (x₂,y₂,z₂) can be expressed by a 2D integration over the entire focal-plane domain (u₂, v₂), i.e.,

$${\vec{U}}_{2} ( {x}_{2} , {y}_{2} , {z}_{2} ) = \frac{{C}_{2}}{f} \int {\int }_{( {u}_{z} , {v}_{z} )} \vec{{H}_{2}} ( {u}_{2} , {v}_{2} )$$

$$exp [ \frac{- j π {z}_{2} ( {u}_{2}^{2} + {v}_{2}^{2} )}{λ {f}^{2}} ] exp [ \frac{- j 2 π ( {u}_{2} {x}_{2} + {v}_{2} {y}_{2} )}{λ f} ] {du}_{2} {dv}_{2} ,$$

where C₂=Constant−2 (complex), z₂ (lᵢ−f).

In above equation, function [symbol] (x₂,y₂, z₂) has also two phase-only terms enclosed within two pairs of brackets. Inside the first pair of brackets is a quadratic phase term of (u₁, v₁), and inside the second pair of brackets is a linear phase term of (u₁, v₁). In operation, these two phase-only terms serve as complex wavefront filters/selectors. For an individual complex wavefront [symbol] (u₂,v₂) whose quadratic phase term and its linear phase term are both exactly conjugate-matched distributions (with the exact opposite phase values) with respect to the quadratic and linear phase terms of complex function [symbol] (x₂, y₂, z₂), we receive an impulse response (i.e., a focused point) at 3D output point Q(x₂,y₂, z₂). Otherwise, for all other (numerous) complex wavefronts emerged from domain (u₂, v₂) whose quadratic phase term and its linear phase term are not (both) exactly conjugate-matched distributions (with the exact opposite phase values) with respect to the quadratic and linear phase terms of complex function [symbol] ₂(x₂,y₂,z₂), the integrated response/contribution to 3D image point Q(x₂,y₂,z₂) is averaged out and yields zero value. This filtering/selecting property can be called orthogonality between different wavefronts. Further, it is due to this filtering/selecting property (orthogonality) between different wavefronts that provides the foundation for refocusing/reconstructing each and every individual three-dimensional image point from numerous superposed Fresnel-styled quadratic phase zone (FQPZ) data at the FPDA. This uniquely matching wavefront is,

$${\vec{H}}_{2} [ ( {u}_{2} , {v}_{2} ) = > ( {x}_{2} , {y}_{2} , {z}_{2} ) ] = {C}_{3} exp [ \frac{+ j π {z}_{2} ( {u}_{2}^{2} + {v}_{2}^{2} )}{λ {f}^{2}} ] exp [ \frac{+ j 2 π ( {u}_{2} {x}_{2} + {v}_{2} {y}_{2} )}{λ f} ]$$

wherein notation [(u₂,v₂)=>(x₂,y₂,z₂)] stands for “a unique wavefront (thus a unique FQPZ) being specifically selected/filtered from the whole focal plane (u₂,v₂) that is converging/focusing a unique 3D image point Q(x₂, y₂,z₂).”

FIG. 13C shows [symbol] [(u₂,v₂)=>(x₂,y₂,z₂)], the particular Fresnel-styled quadratic phase zone (FQPZ) that is uniquely selected/picked out at the display array by the orthogonality among different (numerous) wavefronts. This uniquely selected Fresnel-styled quadratic phase zone (FQPZ) generates a unique wavefront that has a unique normal direction and a unique curvature. After passing lens L₂, the so-generated unique wavefront converges to a unique three-dimensional imaging point in the three-dimensional image space, whereby the radius of curvature (R′_{WCO}) of the FQPZ determines the longitudinal coordinate (z₂) of the three-dimensional imaging point, and the normal-directional-vector ( [symbol] ) of the FQPZ at origin point W₂(0,0) of the display array determines the transverse coordinates (x₂, y₂) of the three-dimensional imaging point. (See R′_{WCO} and [symbol] on FIG. 13C.) Finally, FIG. 13B (together with FIG. 6B) illustrates 3D rectilinear mapping relationship from a 3D object point P(x₁, y₁, z₁) to a 3D displayed point Q(x₂, y₂, z₂). Recall the case of a hypothetically synthesized/fused afocal optical system (AO) (See FIG. 5 and related discussions), wherein a 180-degrees swap of coordinates in 3D spaces was involved there, i.e., (x₂, y₂, z₂)=(−x₁, −y₁, z₁). In RTDH-CD, that issue can be easily corrected by a 180-degree swap at the compression domain, letting (u₂, v₂)=(−u₁, −v₁). In the end, the overall transforming relationship from a 3D object point P(x₁, y₁, z₁) to a 3D image point Q(x₂, y₂, z₂) is a rectilinear transformation with tri-unity-magnifications (TUM), i.e., (x₂, y₂, z₂)=(x₁, y₁, z₁).

Further, because focal length of both lenses (L₁ and L₂) in FIG. 6A and FIG. 13A are identical (i.e., f₁−f₂−f), the system in FIG. 4B is a special tri-unitary-magnification system, i.e., all the three linear magnifications in three directions equal to unity/one (i.e., Mₓ=M_{y}=M_{z}=1), and invariant with respect to space variations.

Thus, the overall system in FIG. 4B (or 4A) may be referred to as a three-dimensional tri-unitary rectilinear transforming (3D-TrURT) system (albeit by means of synthesizing/fusion between two remotely located subsystems).

### § 5.8 Phase-Only Display Arrays

Noting that most currently available display arrays around us are power/intensity-based devices, i.e., the signals being controlled at each pixel location is an optical power/intensity-value (or an amplitude-value), phase values are normally ignored (e.g., an LCD or plasma display panel). Owing to lack of direct availability of complex-valued display devices, development and utilization of corresponding complex-pixel-valued or phase-only pixel-valued display devices become valuable for a digital holographic 3D display subsystem. Since a phase-only pixel-valued display device requires only one controlled parameter at each individual/physical pixel, it offers the advantage of simplicity over fully complex pixel-valued display devices (if available). The following sections present examples of phase-only display devices (arrays); afterwards, example means/solutions that utilize phase-only pixel arrays to display optical complex wavefronts, functionally and equivalently, are described.

### § 5.8.1 Example PA-NLC Phase-Only Display Arrays

Referring back to the phase-only display arrays (PODA) in the upper right portion of FIGS. 4A, 4B and 13A-13C, FIG. 14A illustrates the phase-only modulation process of one pixel of a conventional parallel aligned nematic liquid crystal (PA-NLC) transmission array. P is the pixel width. While only a transmission mode LC array is shown, the same mechanism applies also to a reflection mode LC array. At left side, when no voltage is applied (V=0, Θ_{LC}=0), it shows the crystal cells are all aligned in a horizontal direction. At middle portion, when a voltage is applied, it shows the crystal cells are rotate an angle Θ_{LC} from initial direction, and it thus affects the effective optical thickness between incoming and outgoing light. The PA-NLC can advantageously be brought into transmission or reflection mode, depends on application. When both top and bottom electrodes are transparent (e.g., ITO films), the pixel cell is transparent. At right side, a polarized light beam is transmitted through the PA-NLC cell, whereas the direction of beam polarization is same as orientation of the crystals as shown in the graph at left-side. At an LC status as shown in the middle graph (Θ_{LC}≠0), the optical beam path is shorter than the status shown at the left graph (Θ_{LC}=0). The phase advancement (modulation) of the light beam is given as,

$$ΔΦ = \frac{2 π}{λ} ( δ n ) {d}_{LC} ,$$

where d_{LC} is thickness of LC layer, δn is change of LC refraction index. Alternatively, the device can be brought into a reflection mode, by coating an inner surface of either top or bottom electrode with a mirror reflector.

### § 5.8.2 Example Elastomer- (or Piezo-) Phase-Only Display Array

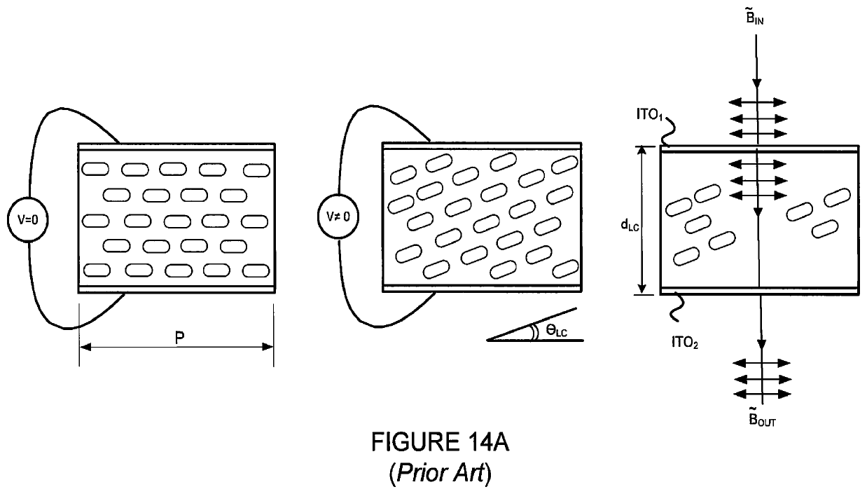

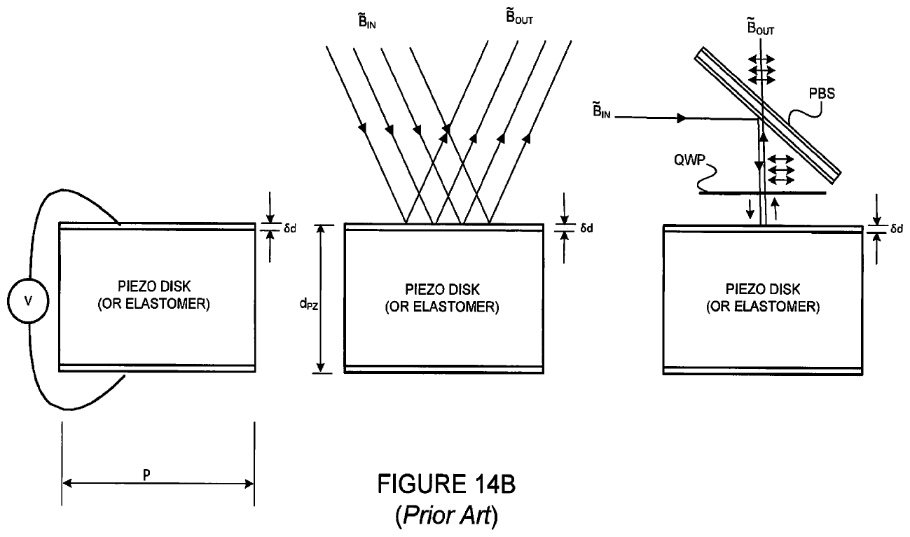

Referring back to the phase-only display arrays (PODA) in the upper right portion of FIGS. 4A, 4B and 13A-13B, FIG. 14B illustrates the phase-only modulation process of one pixel of a conventional elastomer-based or piezo-based reflective mirror array, whereas it affects the optical path between the incoming and outgoing light in two alternative arrangements. As is known, the elastomer/piezo disk thickness contracts when V>0. P is the pixel width, and d_{PZ} is thickness elastomer/piezo disk. As voltage increases, d_{PZ} decreases by amount δd. In operation, an electro-static force between +/− electrodes causes compression of the elastomer (or piezo). At top surface of the elastomer/piezo disk, it is a reflective mirror. The light beam input can be along a normal direction of the reflective mirror (shown at right graph), or at a small angle (θ<<1) off the reflective mirror's normal direction (shown at middle graph). B_{IN} is incoming light beam and B_{OUT} outgoing light beam. As shown at middle graph, for phase modulating at slight off-normal direction (θ<<1), the phase retardation change (δϕ) due to δd, is: δϕ=4π(δd) cos(θ)/λ. As shown at right graph, for phase modulating at on-axis B_{IN} and B_{OUT}, δϕ is (phase retardation change due to δd) is: δϕ=4π(δd)/λ. In FIG. 14B, PBS is polarization beam split, and QWP is quarter-wave plate.

### § 5.8.3 Parrellelism-Guided Digital Mirror Devices (PG-DMD)

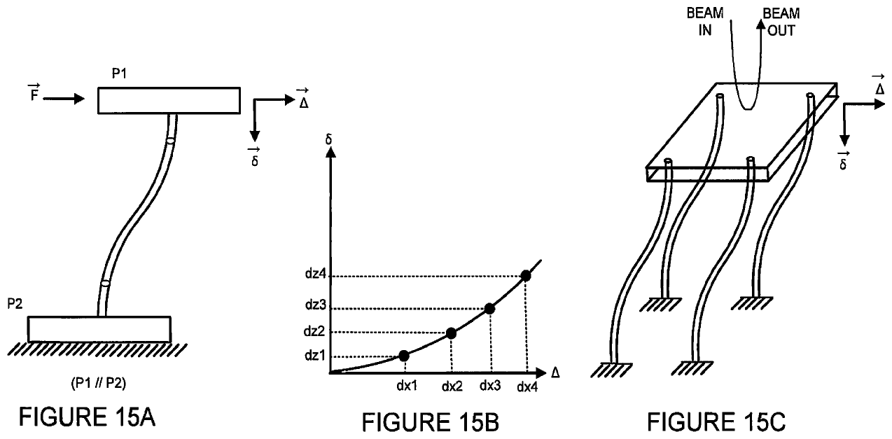

Referring back to the phase-only display arrays (PODA) in the upper right portion of FIGS. 4A, 4B and 13A-13C, FIGS. 15A-15C illustrate parallelism-guided digital micro-mirror devices (PG-DMD, only a single element/pixel is shown), where \vec{Δ} and \vec{δ} are two modes of mirror displacements. FIG. 15A illustrates a flexure deflection column, wherein the column is a slim cylinder (has circular cross-section) and thus has circular symmetric response properties at all horizontal directions over 360°. FIG. 15B is a plot showing a calibration curve between first and second displacements (\vec{Δ} and \vec{δ}). FIG. 15C illustrates a mirror pixel with 4-supporting columns. In these figures, A is primary (horizontal and in-plane) displacement and δ is secondary (vertical and out-of-plane) displacement. The device possesses the following properties. First, thanks to the parallelism-guided modes of movements, plate P1 remains parallel to plate P2 at all times, regardless of the plate motion. Second, δ is a function of Δ, and this function is invariant at all horizontal directions of \vec{Δ} (ranging from 0 to 360 degrees). Finally, the relationship δ<<Δ is valid at all displacement states. Consequently, this very fine vertical displacement (\vec{δ}) is effectively used for precise modulation of optical path difference.

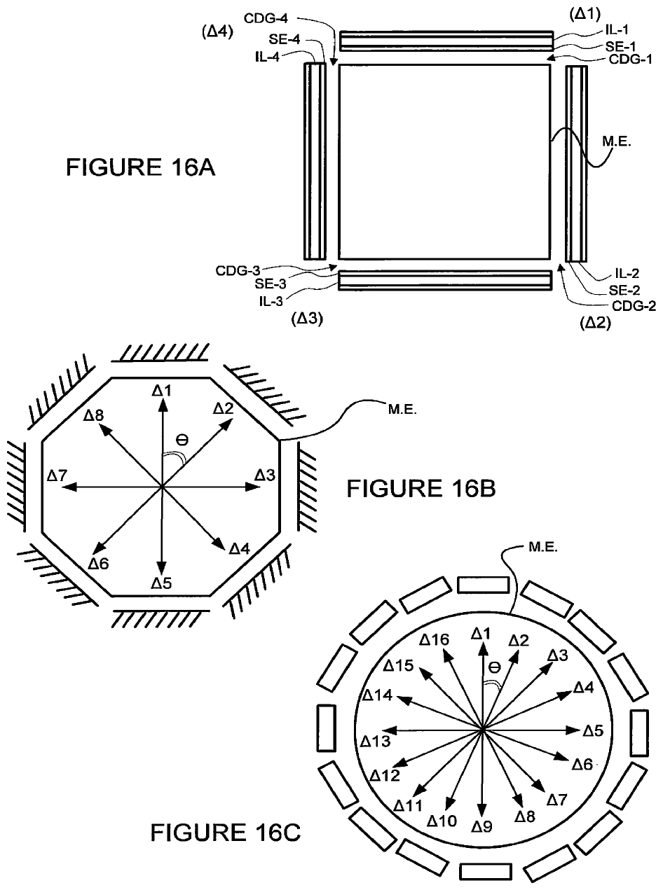

FIGS. 16A-16C illustrate various electro-static mirror devices and their discrete stable displacement states of the PG-DMD. The mirror device of FIG. 16A has 4-sides (N=4, n=2) and 4-stable states (Δ₁ to Δ₄), the mirror device of FIG. 16B has 8-sides (N=8, n=3) and 8-stable-states (Δ₁ to Δ₈), and the circular mirror device of FIG. 16C has 16-sides (N=16, n=4) and 16-stable-states of displacements (Δ₁ to Δ₁₆). Here, “n” is used to represent number of “bits” and “N” is used to represent total number of “steps” of stable-states of the PG-DMD.

In FIG. 16A, (N=4, n=2), central piece ME is a mobile electrode (e.g., a metallic plate connected electrically to a base plate/electrode). The top surface of ME is flat and reflective (e.g., a metal/Al mirror surface), and the base plate/electrode (not shown) can be made of, e.g., Al-alloy, and is connected to a common electric ground. IL-i (i=1, 2, 3, 4) is an insulating layer such as SiO₂ (between pixels/adjacent). SE-i is a static electrode (e.g., Al alloy) that is controlled by bi-stable voltage states (ON/OFF). At a given time, only one static electrode is turned to a ON voltage. Thus, central piece ME (thus, mirror plate) is resting toward only one side-pole (i.e., static electrode). CDG-i is a controlled/calibrated deflection gap (=Δᵢ, in a horizontal direction). MDP-i is a displacement perpendicular to mirror surface (=δᵢ, in vertical direction).

In FIG. 16B, the device has 8 sides and it encode n=3 bits, N=8 levels of phase modulations steps. Angular separation between two adjacent sides is (Θ=45) degrees, and the 8-stable-displacement states are (Δ₁ to Δ₈).

In FIG. 16C, the device has 16 sides and it encode n=4 bits, N=16 levels of phase modulation. Angular separation between two adjacent sides is (Θ=22.5) degrees, and the 16-stable-displacement states are (Δ₁ to Δ₁₆). In FIG. 16C, (N=16, n=4), 16 sides encode 4 bits. 0=22.5 degrees. This can be extended to (N=2ⁿ) sides where n is positive integer (n=2, 3, 4, 5 . . . ).

In general, a total vertical displacement of one wavelength (λ) is equally divided into N levels/steps, wherein N=2ⁿ (n=2, 3, 4, 5 . . . ). Thus, each vertical displacement step offers an optical path difference (OPD) of an 1/N^{th} wavelength (λ/N), and a phase advance or retardation difference of an 1/N-th of one cycle (2π/N). It has been proved that phase-only digital mirror devices (DMD) often deliver decently high optical diffraction efficiencies (at first effective order), even while being controlled at limited number of discrete levels/depths. Specifically, at N stepping simulated levels, the effective efficiency of a primary (first) diffraction order (optically diffracted) is: 41% @ N=2; 81% @ N=4; 91% @ N=6; 95% @ N=8; 98% @ N=12, and 99% @ N=16. (See, e.g., numerical simulation results by G. J. Swanson, Binary Optics Technology: The Theory and Design of Multi-level Diffractive Optical Elements, Technical Report 854, Lincoln Laboratory, MIT, Lexington, Mass., Aug. 14, 1989.)

### § 5.9 from Complex Hologram to Phase-Only Hologram—Digital Phase-Only Encoder (DPOE)

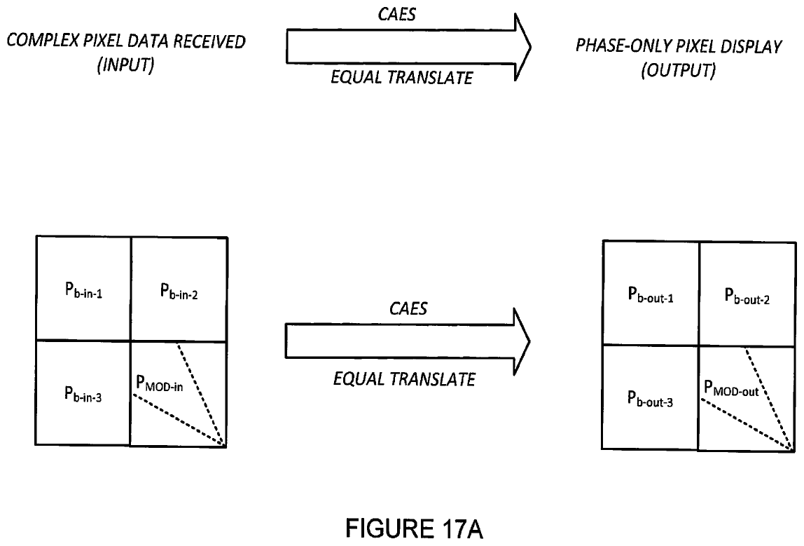

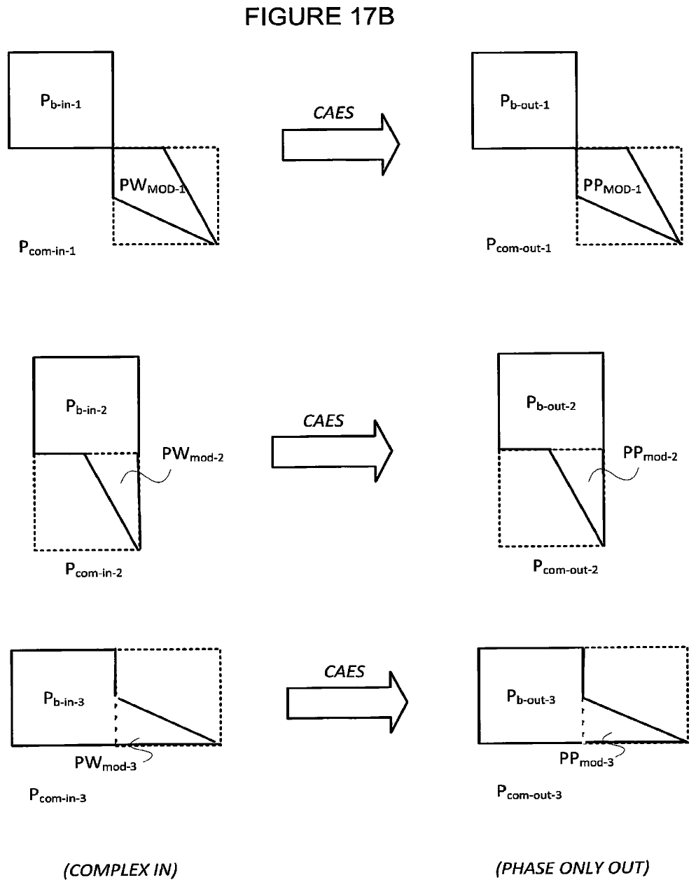

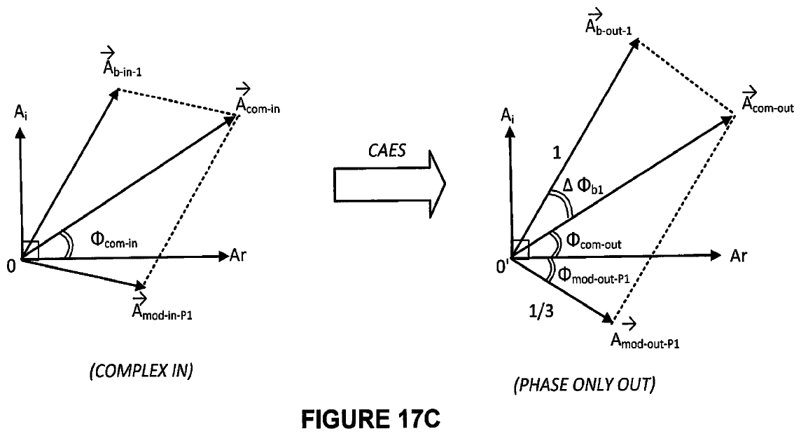

Referring back to the DPOE of FIGS. 4A, 4B and 13A, FIGS. 17A-17C, 18A and 18B illustrate examples of how complex hologram signals can be encoded (synthesized) to phase-only data signals for a phase-only display array. CAES stands for “Complex-Amplitude Equivalent Synthesizer”. More specifically, FIG. 17A illustrates a 2×2 segmentation from the complex input array (left side) and the equivalently encoded 2×2 phase-only array for output to display (right side), FIG. 17B illustrates pictorial presentation of three partitioned and synthesized functional pixels, and FIG. 17C illustrates a vector presentation of CAES process with regard to each functional pixel. Additionally, FIG. 17A illustrates a 4-for-3 scheme in which 3 functional pixels are compounded from 4 complex-valued pixels (left side) or encoded into 4 phase-only pixels (right side). FIG. 17B illustrates the formation of each functional compound pixel from complex pixel data input (left side) and for phase-only pixel output (right side). At a 2×2 segmentation, the fourth complex input pixel (P_{mod-in}) is further divided equally into three partial pixels, i.e., [symbol] _{mod-1}, [symbol] _{mod-2}, [symbol] _{mod-3}. Then functional/conceptual complex pixels are formed by:

[symbol]

_{com-in-1}= [symbol] _{b-in-1}+ [symbol] _{mod-1},

[symbol]

_{com-in-2}= [symbol] _{b-in-2}+ [symbol] _{mod-2}, and

[symbol]

_{com-in-3}= [symbol] _{b-in-3}+ [symbol] _{mod-3},

wherein [symbol] _{b-in-1}, [symbol] _{b-in-2}, [symbol] _{b-in-3} represent the first three complex input pixels.

In FIG. 17C, the left side represents the input and the right side represents the output. In this vector presentation of each functional pixel, the phase corresponds to the angle and the amplitude corresponds to the length. For the translation process of the Complex-Amplitude Equivalent Synthesizer (CAES), it involves the following steps:
1) First, at left side, a compound vector ( [symbol] _{com-in}) is obtained/composed from two complex input vectors ( [symbol] _{b-in-1}+ [symbol] _{mod-in-p1}> [symbol] _{com-in});
2) Following the role of CAES, a right side compound vector ( [symbol] _{com-out}) is assigned the exact same value as [symbol] _{com-in}, i.e., [symbol] _{com-in}=> [symbol] _{com-out};
3) At right side, the compound vector ( [symbol] _{com-out}) is decomposed into 2 phase-only vectors ( [symbol] _{com-out}> [symbol] _{b-out-1}+ [symbol] _{mod-out-p1}). (Note that now we know the amplitudes of the two phase-only vectors ( [symbol] _{b-out-1} and [symbol] _{mod-out-p1}) are 1 and ⅓, respectively, and we are completely given the compound vector ( [symbol] _{com-out}). Hence, we can determine the angles (i.e., phases, ϕ_{b-out-1} and ϕ_{mod-out-p1}) of both phase-only vectors, and thus the two phase-only vectors ( [symbol] _{b-out-1} and [symbol] _{mod-out-p1}) are completely resolved for output.)
4) Then we repeat 3-steps of CAES above, we can also complete resolve other similar phase-only vectors, namely ( [symbol] _{b-out-2} and [symbol] _{mod-out-p2}) and ( [symbol] _{b-out-3} and [symbol] _{mod-out-p3}).
5) Finally, we merge the three resulting partial pixels into the 4^{th} whole phase-only pixel, approximately, by: [symbol] _{mod-out}= [symbol] _{mod-out-p1}+ [symbol] _{mod-out-p2}+ [symbol] _{mod-out-p3}.

At this stage, all the 4 phase-only vectors for outputs to phase-only display array are completely solved, i.e., ( [symbol] _{b-out-1}, [symbol] _{b-out-2}, [symbol] _{b-out-3}, [symbol] _{mod-out}). Further, in practice, 4-for-3 encoding algorithm may not always/necessarily have solutions, especially at areas of low-level inputs (dark areas). In such cases (dark input areas), we use a 2-for-1 encoding algorithm. The actual encoding algorithm to be used at each input area can be changed dynamically, with computer processing (decision-making). For example, the 4-for-3 algorithm can be always tried first. If there is no solution, then it try to find a solution using the 2-for-1 algorithm, automatically.

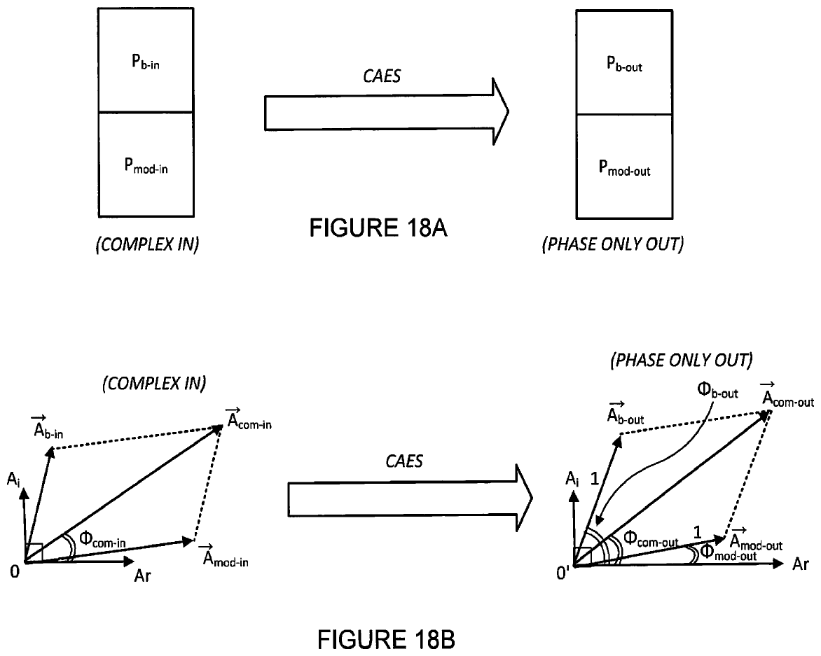

FIG. 18A illustrates 1×2 segmentation and FIG. 18B illustrates a vector presentation of a functional pixel, demonstrating the 2-for-1 algorithm. In FIG. 18B, at the left side, a functional (conceptual) complex pixel is formed from two physical complex pixels by:

[symbol]

_{com-in}= [symbol] _{b-in}+ [symbol] _{mod-in}.

At the right side of FIG. 18B, first a functional (conceptual) complex output pixel value ( [symbol] _{com-out}) is assigned as [symbol] _{com-out}= [symbol] _{com-in}, and then it is decomposed into two phase-only pixels ( [symbol] _{b-out} and [symbol] _{mod-out}). Here, both phase-only pixels ( [symbol] _{b-out} and [symbol] _{mod-out}) have a unity amplitude (i.e., [symbol] _{b-out}= [symbol] _{mod-out}=1). Detailed decomposition process here for this 2-for-1 algorithm is similar to (and simpler than) step-3 of the 4-for-3 algorithm above.

### § 5.10 Integration of RGB Colors

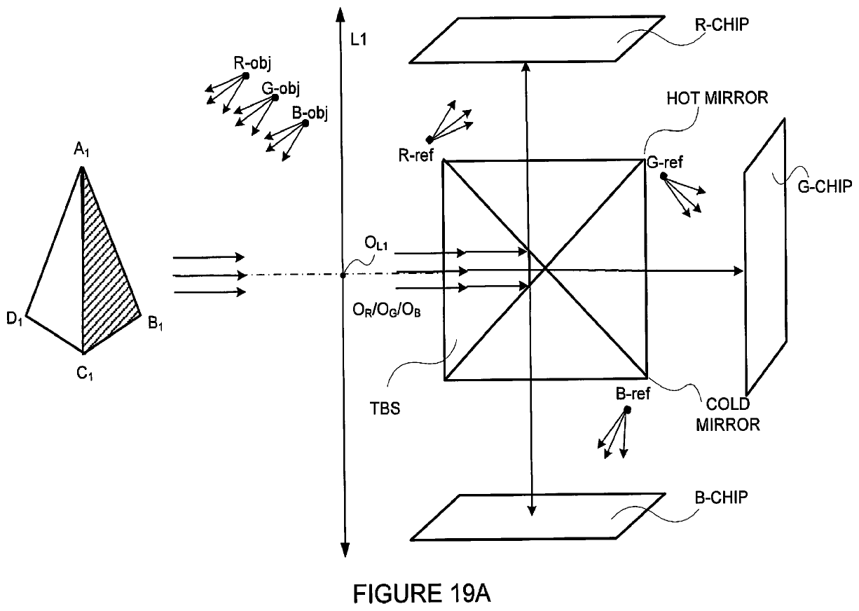

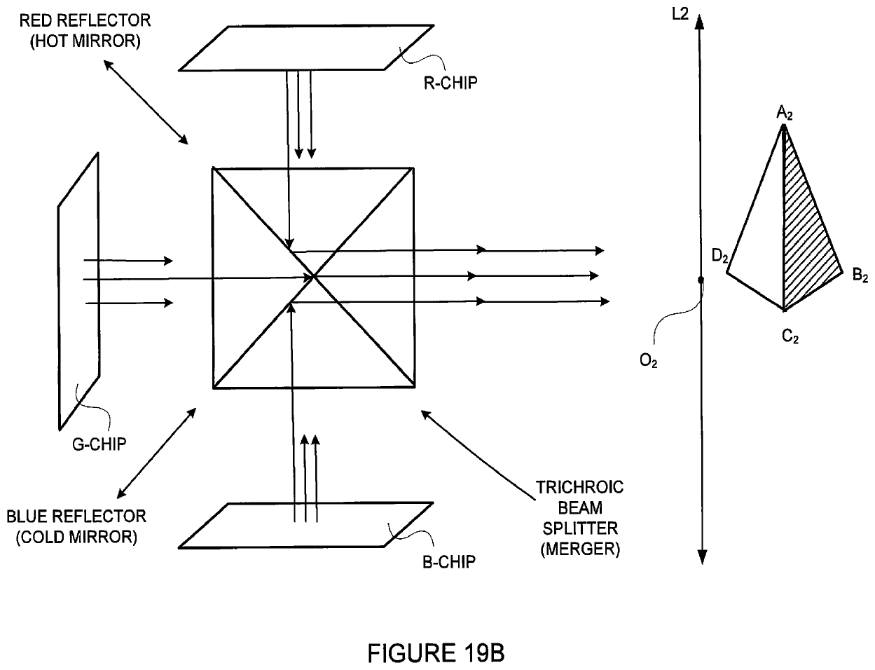

FIGS. 19A and 19B illustrates example ways to integrate separate red, green and blue colors. More specifically, FIG. 19A illustrates RGB partitioning at recording, while FIG. 19B illustrates RGB blending at display. In FIG. 19A, TBS is a trichroic beam splitter, wherein the cold mirror reflects blue light and transmits red and green light, and the hot mirror reflects red light and transmits blue and green light. R-chip, G-chip and B-chip are red, green and blue detector arrays, R-obj, G-obj and B-obj are red, green and blue object beams, R-ref, G-ref and B-ref are red, green and blue reference beams, O_{R}, O_{G} and O_{B} are red, green and blue color beams originated from the object. In FIG. 19B, TBS is a trichroic beam merger, the cold mirror reflects blue light and the hot mirror reflects red light. R-chip, G-chip and B-chip are red, green and blue display arrays.

The FOV (field-of-view) at the viewers' side may be further multiplexed by adding transmission-type R/G/B diffraction grating panels at each of the partitioned R/G/B beam path, respectively. Note that R/G/B sources are all highly coherent at any plane. Thus, for purely coherency considerations a diffraction grating panel may be placed at any point along a beam path. However, to avoid or minimize any possible vignette effects of the displayed screen area (L₂), a plane for a grating panel should be chosen prior to the output screen and as close to the output screen (L₂) as possible (e.g., at an exterior surface of the TBS—trichroic beam splitter).

### § 5.11 System Refinements

### § 5.11.1 Horizontal Augmentation of Parallax by Array Expansion/Mosaic at Recording and Display

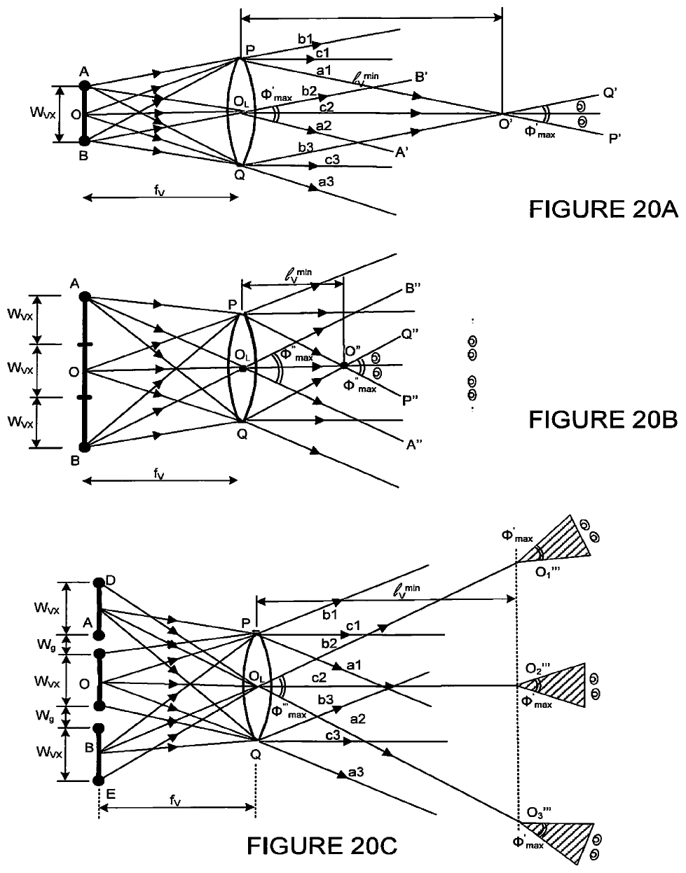

FIGS. 20A-20C illustrate alternative ways to provide horizontal augmentation of viewing parallax (perspective angle) by array mosaic expansions at both recording and display arrays. FIG. 20A illustrates the case using a single array, with an array width=a. Note that the more users sitting at both sides off optical axis can see dark spots. FIG. 20B illustrates side-by-side (continuous) mosaic of 3 arrays, with each array having a width=a, and a total array width=3a. Thus, to avoid the dark spots for multiple users (or viewing positions) in FIG. 20A, the array size can be expanded. In FIG. 20B, as benefits of array expansion against FIG. 20A, the maximum angular viewing space (also called horizontal parallax, Φ″ₘₐₓ) is increased three times approximately, and the minimum viewable distance ( [symbol] ₘᵢₙ) from viewing aperture/screen (A_{V}=P̅Q̅) is reduced three times approximately, without seeing any dark spots on the screen. Finally, FIG. 20C illustrates discrete mosaic of 3 arrays, with each array width=a, an inter-array gap=b, and a total array width=3a+2b. The total parallax (angular viewing space) is: (Φₘₐₓ^{TOT}≈(3W_{VX}+2W_{g})/(2fᵥ). The horizontal parallax of each viewing zone is Φₘₐₓ¹≈W_{VX}/(2fᵥ). In FIG. 20C, lᵥ^{min}≈Aᵥfᵥ/Wᵥₓ, where fᵥ is the focal length of the viewing screen (i.e., OTE₂), A_{V} is the viewing aperture (A_{V}=P̅Q̅), and [symbol] ₘᵢₙ is the minimum viewable distance from viewing aperture/screen, without seeing any dark spots on the screen. Note that horizontal augmentation of viewing parallax can be made by array mosaic expansions at both recording and display arrays. Likewise (not shown), in a focal-plane compression-domain digital holographic recording (FPCD-DHR) sub-system (as in FIGS. 4A, B and 6A), horizontal augmentation of angular field-of-view (FOV) of recorded objects can be achieved (in a similar manner as in display) via either contiguous or discrete array mosaic expansions at the two-dimensional focal plane detector array (FPDA).

### § 5.11.2 Systems for Giant Objects and Gigantic Viewing Screens

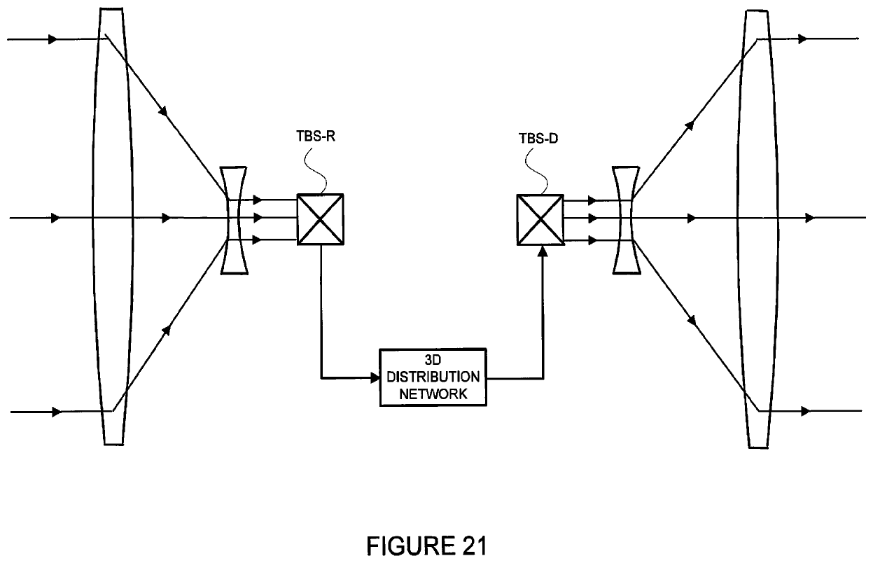

As shown in FIG. 21, a large screen may be implemented using optical telephoto subsystems having a large primary lens at both recording and display. Such systems can be applied to replace the used lenses in FIG. 4A, and make the system capable to capture oversized objects by the recording subsystem and to display oversized 3D images via a viewing screen at display. In FIG. 21, TBS-R stands for a tri-chronic beam splitter at recording and TBS-D stands for a tri-chronic beam splitter (merger) at display. Each pair of a large primary convex lens and a small secondary concave lens constitutes an optical telephoto subsystem.

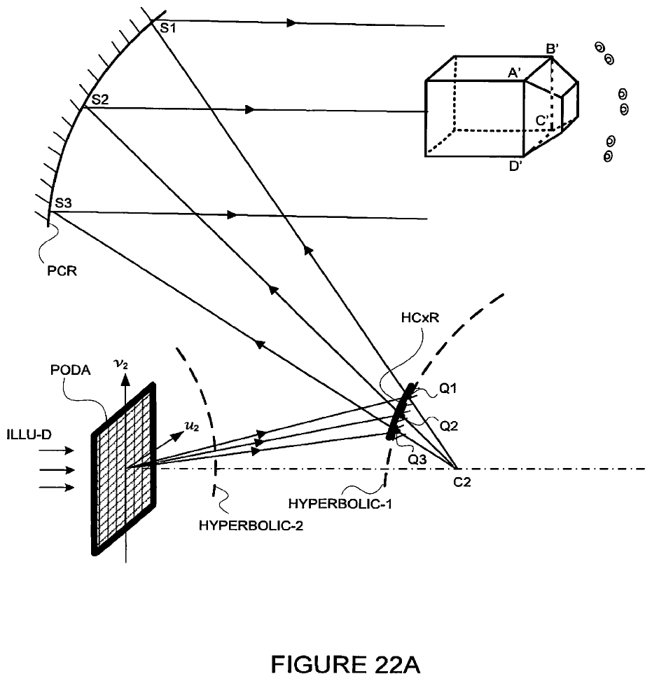

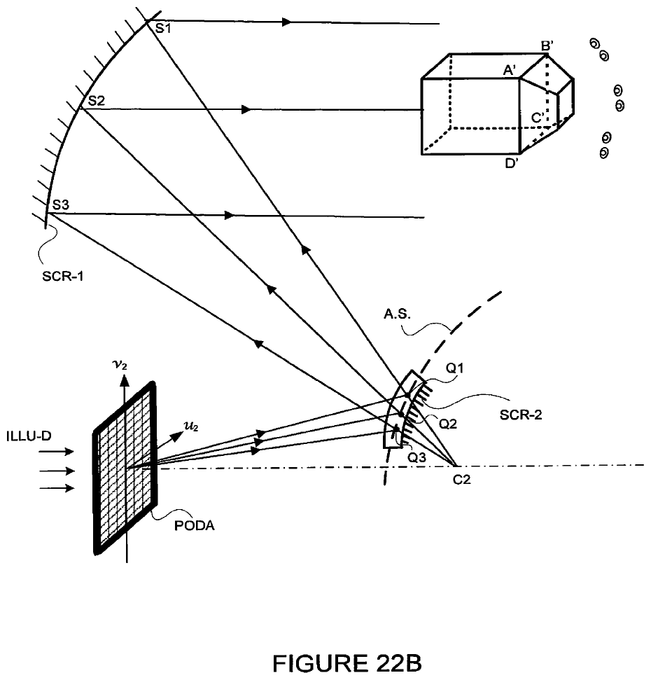

For the system in FIG. 4B, super-large viewing screens may be provided using multi-reflective panels, as shown in FIGS. 22A and 22B. More specifically, in FIG. 22A, a parabolic concave primary (PCR) and a hyperbolic convex secondary (HCxR) are provided. In FIG. 22B, a spherical concave primary (SCR-1) and spherical convex secondary (SCR-2) with thin Mangin-type correction are provided. In these Figures, PCR is a parabolic concave reflector, HCxR is a hyperbolic convex reflector, SCR-1 is a spherical concave reflector, SCR-2 is a spherical convex reflector and AS is an achromatic surface placed between two types of transmission materials (i.e., crown and flint types). Although only display subsystems are shown in FIGS. 22A and 22B, similar implementation can be applied to the recording subsystem of the system in FIG. 4B, which provides gigantic recording panel apertures for effective registration of super-sized objects and scenes (e.g., 15 m (Width)×5 m (Height) for near objects/points, or 1500 m (Width)×500 m (Height) for far objects/points; refer to FIG. 6E for discussions regarding “l_{OB}” and “l_{OA}” for “near” and “far” objects/points).

### § 5.11.3 Microscopic, Telescopic and Endoscopic 3D Display Systems

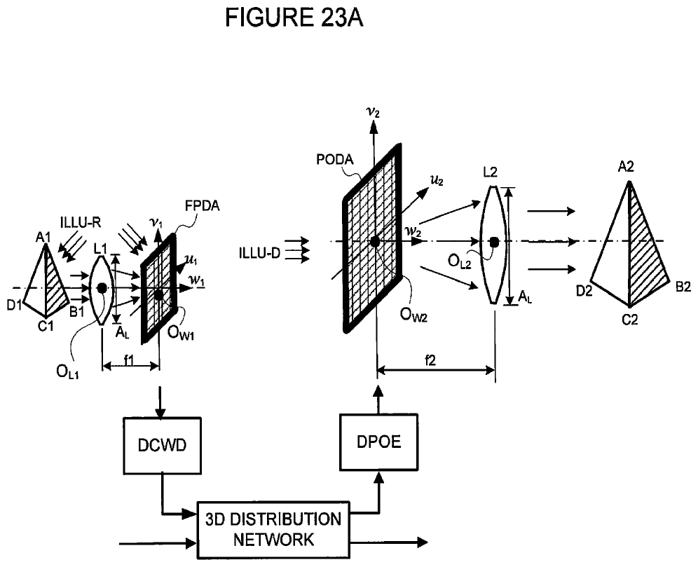

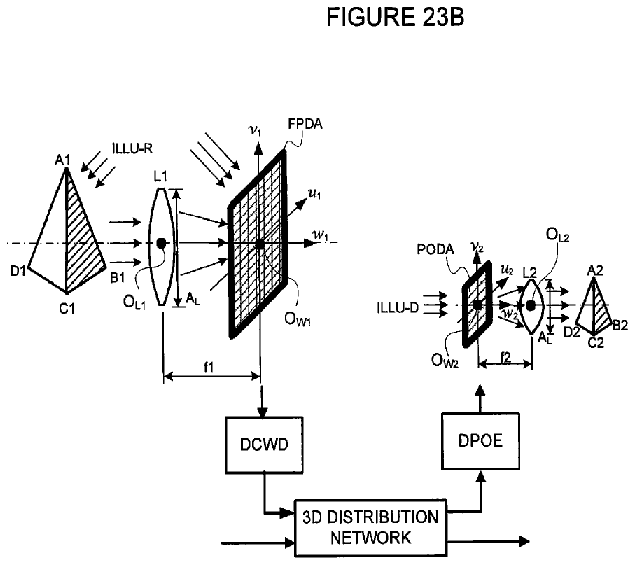

FIG. 23A is a microscopic rectilinear transforming digital holographic 3D recording and display system (M-RTDH), in which M>>1, f₂>>f₁, A₂/A₁=f₂/f₁=M_{LAT}>>1, and M_{LONG}=M_{LAT2}. This system follows the same principle of operation as the system of FIG. 4A, except that f₂>>f₁.

FIG. 23B shows for a telescopic rectilinear transforming digital holographic 3D recording and display system (T-RTDH), where M<<1, f₂<<f₁, A₂/A₁=f₂/f₁=M_{LAT}<<1, and M_{LONG}=M_{LAT2}. This system follows the same principle of operation as the system of FIG. 4A, except that f₂<<f₁.

In both FIGS. 23A and 23B, M denotes system magnification, M_{LONG} denotes system longitudinal/depth magnification, M_{LAT} denotes system lateral/transverse magnification, f₁ and A₁ denote focal length and optical aperture, respectively, of optical transforming/compressing element (e.g., lens L₁) at 3D recording subsystem, and f₂ and A₂ denote focal length and optical aperture, respectively, of optical transforming/de-compressing element (e.g., lens L₂) at 3D display subsystem.

Likewise, for the recording and display system of FIG. 4B (or 4A), a three-dimensional endoscopic rectilinear transforming digital holographic (E-RTDH) system can be made (not shown), in which M≥1, f₂≥f₁, A₂/A₁=f₂/f₁=M_{LAT}≥1, and M_{LONG}=M_{LAT}²≥1. Special constructions for an E-RTDH system can be made (albeit not shown in Figures), for example, by adding a transparent front window (well-sealed and water-proof), miniaturization, and hermetical packaging for the entire FPCD-DHR subsystem.

### § 5.11.4 Alternative Data Input Channels from CGH

FIG. 24 is the same as FIG. 12, but artificially generated holograms of simulated virtual objects [CG_{C}H(u₁,v₁)], i.e., computer generated complex holograms, are input instead of (or in addition to) electro-optically captured and digital decoded holograms. Thus, the finally displayed 3D images can be originated from (1) electro-optically captured objects (from physical reality), (2) artificially generated/simulated objects (from virtual reality), or (3) both electro-optically captured objects and artificially generated/simulated virtual objects (combination/fusion from both physical reality and virtual reality).

To produce [CG_{C}H(u₁,v₁)] numerically, assume [symbol] _{VRO}(x₁,y₁,z₁) is the complex amplitude of a 3D point of the simulated virtual reality objects (VRO) located at (x₁, y₁, z₁) of the 3D virtual reality space. We integrate over all the virtual object points of the 3D virtual reality space in the following,

$$\vec{CGcH} ( {u}_{1} , {v}_{1} ) = {C}_{VRO} {\int }_{{z}_{1}} exp [ \frac{j π {z}_{1} ( {u}_{1}^{2} + {v}_{1}^{2} )}{λ {f}^{2}} ]$$

$$\int {\int }_{( {x}_{1} , {y}_{1} )} {\vec{U}}_{VRO} ( {x}_{1} , {y}_{1} , {z}_{1} ) exp [ \frac{- j 2 π ( {x}_{1} {u}_{1} + {y}_{1} {v}_{1} )}{λ f} ] {dx}_{1} {dy}_{1} {dz}_{1} ,$$

wherein C_{VRO} is a constant, and f is a simulated focal length of a simulated transformation element (a virtual element which is similar to lens L₁ or HRCMS in FIGS. 6A and 6B). Also similar to the 3D-to-2D transformation/compression operation as illustrated in FIG. 6B, above analytically/numerical integral may take place firstly over one 2D slice from the 3D virtual object space and then add together with all other slices of the entire 3D virtual object space.

What is claimed is:

1. A rectilinear-transforming digital holography (RTDH) system for recording and displaying virtual, real, or both virtual and real, orthoscopic three-dimensional images, the system comprising:
a) a focal-plane compression-domain digital holographic recording/data capturing (FPCD-DHR) sub-system including
1) coherent optical illuminating means for
providing a reference beam and
illuminating a three-dimensional object such that wavefronts are generated from points on the three-dimensional object,
2) a first optical transformation element for transforming and compressing all the wavefronts generated from the points of the three-dimensional object into a two-dimensional complex wavefront distribution pattern located at a focal plane of the first optical transformation element,
3) a two-dimensional focal plane detector array (FPDA) for
capturing a two-dimensional power intensity pattern produced by an interference between, (i) the two-dimensional complex wavefront pattern generated and compressed by the first optical transformation element and (ii) the reference beam, and
outputting signals carrying information corresponding to captured power intensity distribution pattern at different points on a planar surface of the two-dimensional detector array, and
4) a digital complex wavefront decoder (DCWD) for decoding the signals output from the focal plane detector array (FPDA) to generate digital-holographic complex wavefront data signals,
wherein the two-dimensional focal plane detector array (FPDA) is positioned at a focal plane of the first optical transformation element, and wherein a distance from the two-dimensional focal plane detector array (FPDA) to the first optical transformation element corresponds to a focal length of the first optical transformation element;
b) a 3D distribution network for receiving, storage, processing and transmitting the digital-holographic complex wavefront data signals generated by the digital complex wavefront decoder (DCWD) to at least one location; and
c) a focal-plane compression-domain digital holographic display (FPCD-DHD) sub-system located at the at least one location and including
1) a digital phase-only encoder (DPOE) for converting the distributed digital-holographic complex wavefront data signals into phase-only holographic data signals,
2) second coherent optical illuminating means for providing a second illumination beam,
3) a two-dimensional phase-only display array (PODA) for (i) receiving the phase-only holographic data signals from the digital phase-only encoder, (ii) receiving the second illumination beam, and (iii) outputting a two-dimensional complex wavefront distribution based on the received phase-only holographic data signals, and
4) a second optical transformation element for transforming the two-dimensional complex wavefront distribution output from the two-dimensional phase-only display (PODA) array into wavefronts that propagate and focus into points on an orthoscopic holographic three-dimensional image corresponding to the three-dimensional object,
wherein the two-dimensional phase-only display array (PODA) is positioned at a front focal plane of the second optical transformation element, and wherein a distance from the two-dimensional phase-only display array (PODA) to the second optical transformation element corresponds to a focal length of the second optical transformation element;
wherein the relationship between the captured three-dimensional object and the displayed three-dimensional image constitutes a three-dimensional rectilinear transformation;
wherein the displayed three-dimensional image is virtual orthoscopic, or real orthoscopic, or partly virtual and partly real orthoscopic with respect to the three-dimensional object.

2. The rectilinear-transforming digital holography (RTDH) system of claim 1 wherein each of the first and second optical transformation element is a transmission lens, including a telephoto apparatus comprising a pair of a large primary convex lens and a small secondary concave lens.

3. The rectilinear-transforming digital holography (RTDH) system of claim 1 wherein each of the first and second optical transformation element is a parabolic concave mirror reflector, or a spherical concave mirror reflector accompanied by a thin Mangin corrector, or a pair of a parabolic primary concave reflector and a hyperbolic secondary convex reflector, or a pair of a spherical primary concave reflector and a spherical secondary convex reflector accompanied by a thin Mangin corrector.

4. The rectilinear-transforming digital holography (RTDH) system of claim 1 wherein the focal plane detector array (FPDA) is a CCD array, or a CMOS array.

5. The rectilinear-transforming digital holography (RTDH) system of claim 1 wherein the digital complex wavefront decoder (DCWD) includes a digital demodulator which is an emulated function of inverse-normalized-reference (INR).

6. The rectilinear-transforming digital holography (RTDH) system of claim 1 wherein the reference beam has an oblique spatial frequency offset from system optical axis [sin(Θ_{REF})], where (Θ_{REF}) is angular offset between system optical axis and axis of the reference beam.

7. The rectilinear-transforming digital holography (RTDH) system of claim 6 wherein the oblique spatial frequency offset from system optical axis [sin(Θ_{REF})] is great than 1.5-times (1.5×) the reciprocal of the F-number (F_{#}) of first optical transformation element [i.e., sin(Θ_{REF})>1.5/F_{#}].

8. The rectilinear-transforming digital holography (RTDH) system of claim 1 wherein the reference beam is collimated, or diverging from a single point, or converging to a single point.

9. The rectilinear-transforming digital holography (RTDH) system of claim 1 wherein the first illuminating beam, the reference beam and the second illuminating beam are each provided from three red, green and blue laser sources.

10. The rectilinear-transforming digital holography (RTDH) system of claim 9 wherein the three red, green and blue laser sources are diode lasers or diode-pumped solid-state lasers.

11. The rectilinear-transforming digital holography (RTDH) system of claim 9 wherein the three red, green and blue laser sources for the first illuminating beam and the reference beam are operated under a synchronized stroboscopic mode.

12. The rectilinear-transforming digital holography (RTDH) system of claim 1 wherein the second illumination beam is expanded and collimated and is impinged onto the display array along its normal direction.

13. The rectilinear-transforming digital holography (RTDH) system of claim 1 wherein the second illumination beam is expanded and collimated and is impinged onto the display array along an oblique direction.

14. The rectilinear-transforming digital holography (RTDH) system of claim 1 wherein the digital phase-only encoder (DPOE) includes a 4-for-3 complex-amplitude equivalent synthesizer (CAES).

15. The rectilinear-transforming digital holography (RTDH) system of claim 1 wherein the digital phase-only encoder (DPOE) includes a 2-for-1 complex-amplitude equivalent synthesizer (CAES).

16. The rectilinear-transforming digital holography (RTDH) system of claim 1 wherein the two-dimensional phase-only display array (PODA) includes transmission-type or reflection-type pixels built from parallel-aligned nematic liquid crystals (PA-NLC).

17. The rectilinear-transforming digital holography (RTDH) system of claim 1 wherein the two-dimensional phase-only display array (PODA) includes reflection-type pixels built on piezo-electric or elastomer-based micro actuators.

18. The rectilinear-transforming digital holography (RTDH) system of claim 1 wherein the two-dimensional phase-only display array (PODA) includes reflection-type pixels built from parallelism-guided digital-mirror-devices (PG-DMD).

19. The rectilinear-transforming digital holography (RTDH) system of claim 1 wherein the input channels to the 3D distribution network includes computer-generated complex holograms (CGcH) from virtual reality objects (VRO).

20. The rectilinear-transforming digital holography (RTDH) system of claim 1 wherein all three linear magnifications in all three space directions from the three-dimensional object to the three-dimensional image equal to unity over a 3D space (i.e., Mₓ=M_{y}=M_{z}=1), and is further called a tri-unity-magnifications rectilinear-transforming digital holography (TUM-RTDH) system.

21. The rectilinear-transforming digital holography (RTDH) system of claim 1 wherein all three linear magnifications in all three space directions from the three-dimensional object to the three-dimensional image are constants over a 3D space and larger than unity (i.e., Mₓ=M_{y}=constant>>1, M_{z}=constant>>1), and is further constructed as a microscopic rectilinear-transforming digital holography (M-RTDH) system.

22. The rectilinear-transforming digital holography (RTDH) system of claim 1 wherein all three linear magnifications in all three space directions from the three-dimensional object to the three-dimensional image are constants over a 3D space and less than unity (i.e., Mₓ=M_{y}=constant<<1, M_{z}=constant<<1), and is further constructed as a telescopic rectilinear-transforming digital holography (T-RTDH) system.

23. The rectilinear-transforming digital holography (RTDH) system of claim 1 wherein all three linear magnifications in all three space directions from the three-dimensional object to the three-dimensional image are constants over a 3D space and larger than or equal to unity (i.e., Mₓ=M_{y}=constant≥1, M_{z}=constant≥1), wherein the FPCD-DHR subsystem is enclosed in a hermetical package having a front-side transparent window, and is further constructed as an endoscopic rectilinear-transforming digital holography (E-RTDH) system.

24. The rectilinear-transforming digital holography (RTDH) system of claim 1 wherein the focal-plane compression-domain digital holographic recording (FPCD-DHR) sub-system includes a trichroic beam splitter (TBS), and wherein the focal-plane compression-domain digital holographic display (FPCD-DHD) sub-system includes a trichroic beam merger (TBM).

25. The rectilinear-transforming digital holography (RTDH) system of claim 1 wherein the focal-plane compression-domain digital holographic recording (FPCD-DHR) sub-system includes horizontal augmentation of angular field-of-view (FOV) of recorded objects via contiguous or discrete array mosaic expansion at the two-dimensional focal plane detector array (FPDA), and wherein the focal-plane compression-domain digital holographic display (FPCD-DHD) sub-system includes horizontal augmentation of viewing parallax (perspective angle) via contiguous or discrete array mosaic expansion at the two-dimensional phase-only display array (PODA).

26. A method for recording and displaying virtual or real, orthoscopic three-dimensional images, the method comprising:
a) providing a reference beam;
b) illuminating a three-dimensional object such that wave fronts are generated from points on the three-dimensional object;
c) transforming and compressing the wave fronts emitted from the points on the three-dimensional object into a two-dimensional complex wavefront distribution pattern;
d) capturing a two-dimensional power intensity pattern produced by an interference between, (i) the generated and compressed two-dimensional complex wavefront pattern and (ii) the reference beam;
e) outputting signals carrying information corresponding to captured power intensity distribution pattern at different points on a plane;
f) decoding the signals to generate digital holographic complex wavefront data signals;
g) distributing the digital holographic complex wavefront data signals to at least one location;
h) converting, at the at least one location, the digital holographic complex wavefront data signals into phase-only holographic data signals;
i) providing a second illumination beam to illuminate a display panel;
j) outputting a two-dimensional complex wavefront distribution output based on the phase-only holographic data signals and the second illumination beam; and
k) transforming the two-dimensional complex wavefront distribution output into wavefronts that propagate and focus into points on an orthoscopic holographic three-dimensional image corresponding to the three-dimensional object.

27. For use in a rectilinear-transforming digital holography (RTDH) system for recording and displaying virtual, real, or both virtual and real, orthoscopic three-dimensional images, a focal-plane compression-domain digital holographic recording (FPCD-DHR) apparatus comprising:
a) coherent optical illuminating means for
providing a reference beam and
illuminating a three-dimensional object such that wavefronts are generated from points on the three-dimensional object;
b) an optical transformation element for transforming and compressing all the wavefronts generated from the points of the three-dimensional object into a two-dimensional complex wavefront distribution pattern located at a focal plane of the optical transformation element;
c) a two-dimensional focal plane detector array (FPDA) for
capturing a two-dimensional power intensity pattern produced by an interference between, (i) the two-dimensional complex wavefront pattern generated and compressed by the optical transformation element and (ii) the reference beam, and
outputting signals carrying information corresponding to captured power intensity distribution pattern at different points on a planar surface of the two-dimensional detector array; and
d) a digital complex wavefront decoder (DCWD) for decoding the signals output from the focal plane detector array (FPDA) to generate digital-holographic complex wavefront data signals,
wherein the two-dimensional focal plane detector array (FPDA) is positioned at a focal plane of the optical transformation element, and wherein a distance from the focal plane detector array (FPDA) to the optical transformation element corresponds to a focal length of the optical transformation element;
wherein a unique wavefront emerged from each three-dimensional object point generates a unique Fresnel-styled quadratic phase zone (FQPZ) at the focal plane detector array (FPDA) whereby the radius of curvature of the FQPZ is determined by the longitudinal coordinate (z₁) of the three-dimensional object point, and the normal-directional-vector of the FQPZ at origin W₁(0,0) of focal plane detector array (FPDA) is determined by the transverse coordinates (x₁, y₁) of the three-dimensional object point.

28. For use in a rectilinear-transforming digital holography (RTDH) system for recording and displaying virtual, real, or both virtual and real, orthoscopic three-dimensional images, a focal-plane compression-domain digital holographic display (FPCD-DHD) apparatus comprising:
a) a digital phase-only encoder (DPOE) for converting the distributed digital-holographic complex wavefront data signals into phase-only holographic data signals,
b) a coherent optical illuminating means for providing an illumination beam;
c) a two-dimensional phase-only display array (PODA) for (i) receiving phase-only holographic data signals, (ii) receiving the illumination beam, and (iii) outputting a two-dimensional complex wavefront distribution based on the received phase-only holographic data signals; and
d) an optical transformation element for transforming the two-dimensional complex wavefront distribution output from the two-dimensional phase-only display array (PODA) into wavefronts that propagate and focus into points on an orthoscopic holographic three-dimensional image corresponding to the three-dimensional object,
wherein the two-dimensional phase-only display array (PODA) is positioned at a front focal plane of the optical transformation element, and wherein a distance from the two-dimensional phase-only display array (PODA) to the optical transformation element corresponds to a focal length of the optical transformation element;
wherein a wavefront emerged from a unique Fresnel-styled quadratic phase zone (FQPZ) on the phase-only display array (PODA) converges to a unique three-dimensional imaging point in the three-dimensional image space, whereby the radius of curvature of the FQPZ determines the longitudinal coordinate (z₂) of the three-dimensional imaging point, and the normal-directional-vector of the FQPZ at origin W₂(0,0) of the phase-only display array (PODA) determines the transverse coordinates (x₂, y₂) of the three-dimensional imaging point.
